(19) United States
(12) Patent Application Publication
(10) Pub. No.: US 2015/0001163 A1
(43) Pub. Date: Jan. 1, 2015

(54) LIQUID PROCESSING SYSTEM AND CONTROL METHOD

(71) Applicant: Kabushiki Kaisha Toshiba, Minato-Ku (JP)

(72) Inventors: Norimitsu ABE, Kanagawa-ken (JP); Takeshi Ide, Tokyo (JP); Shinji Kobayashi, Kanagawa-ken (JP); Akihiro Shirota, Tokyo (JP); Kenji Takeuchi, Tokyo (JP)

(73) Assignee: Kabushiki Kaisha Toshiba, Minato-Ku (JP)

(21) Appl. No.: 14/487,810

(22) Filed: Sep. 16, 2014

Related U.S. Application Data
(63) Continuation of application No. PCT/JP2013/001657, filed on Mar. 13, 2013.

(30) Foreign Application Priority Data
Mar. 16, 2012 (JP) 2012-059745

(51) Int. Cl. C02F 1/32; C02F 1/00

(52) U.S. Cl. CPC C02F 1/325; C02F 1/008; C02F 2303/04; C02F 2209/40; C02F 2209/006; C02F 2201/326; C02F 2201/3227
USPC 210/739; 250/432 R

(57) ABSTRACT

A liquid processing system has: processing units of n stages in which each processing unit includes one or a plurality of processing lines, each processing line includes an ultraviolet ray irradiating unit, and the number of processing lines of an m-th stage processing unit is larger than the number of processing lines of an m+1-th stage processing unit; and adjusting section which adjusts an output of an ultraviolet ray irradiating unit provided to a processing unit of a predetermined stage. An output of an ultraviolet ray irradiating unit provided to a processing unit of a stage other than the predetermined stage is each fixed, and the adjusting section adjusts the output of the let ray irradiating unit provided to the processing unit of the predetermined stage such that a liquid processed in an n-th stage processing unit of a final stage is in a desired processing state.

### CROSS-REFERENCE TO RELATED APPLICATION

This application is based upon and claims the benefit of priority from the prior Japanese Patent Application No. 2012-059745 filed on Mar. 16, 2012, the entire contents of which are incorporated by reference herein. This application is a continuation application of International Application No. PCT/JP2013/001657, file on Mar. 13, 2013.

### FIELD

Embodiments of the present invention relate to a liquid processing system and a control method.

### BACKGROUND

A liquid processing system which irradiates a liquid with ultraviolet rays is known as disclosed in, for example, U.S. Pat. No. 7,385,204. The liquid processing system disclosed in U.S. Pat. No. 7,385,204 has a cylindrical water drum, and lamp housings. The lamp housings are jointed to the water drum crisscross and are formed by circular tubes whose diameters are smaller than the diameters of the water drum. Inside the lamp housing, a plurality of ultraviolet ray irradiating tubes is attached to the lamp housing in parallel to an axis of the lamp housing. The ultraviolet ray irradiating tube has a silica glass tube, and an ultraviolet lamp accommodated in the silica glass tube.

However, the conventional technique does not necessarily control an ultraviolet ray amount to an optimal ultraviolet ray amount in an actual operation of a processing system. Hence, optimization of illumination efficiency and further optimization of operation cost are desired.

### BRIEF DESCRIPTION OF THE DRAWINGS

FIG. 1 is a system diagram illustrating a configuration of a water processing system which uses ultraviolet rays according to a first embodiment.

FIG. 2 is a configuration diagram of an ultraviolet ray irradiating unit.

FIG. 3 is an A-A cross-sectional view of the ultraviolet ray irradiating unit in FIG. 2.

FIG. 4 is a configuration diagram of an ultraviolet ray irradiating tube.

FIG. 5A is a view illustrating an example of a dimension of an ultraviolet lamp.

FIG. 5B is a view illustrating an external dimension of the ultraviolet lamp.

FIG. 6 is a view for explaining an outer diameter, an inner diameter and a flow rate of a pipe defined by the JIS standards.

FIG. 7 is a view illustrating an example of a relationship between an ultraviolet ray intensity and an ultraviolet ray irradiation amount.

FIG. 8 is a processing flowchart (part 1) of the water processing system according to the first embodiment.

FIG. 9 is a processing flowchart (part 2) of the water processing system according to the first embodiment.

FIG. 10 is a system diagram illustrating a configuration of a water processing system according to a second embodiment.

FIG. 11 is a processing flowchart (part 1) of the water processing system according to the second embodiment.

FIG. 12 is a processing flowchart (part 2) of the water processing system according to the second embodiment.

FIG. 13 is a processing flowchart (part 1) of a water processing system according to a third embodiment.

FIG. 14 is a processing flowchart (part 2) of the water processing system according to the third embodiment.

FIG. 15 is a processing flowchart (part 3) of the water processing system according to the third embodiment.

FIG. 16 is a processing flowchart (part 1) of a water processing system according to a fourth embodiment.

FIG. 17 is a processing flowchart (part 2) of the water processing system according to the fourth embodiment.

FIG. 18 is a processing flowchart (part 3) of the water processing system according to the fourth embodiment.

### DETAILED DESCRIPTION

Embodiments will be described below with reference to the drawings. A liquid processing system according to the embodiments is a water processing system. The water processing system according to the embodiments has: processing units of n stages in total (n is a natural number of two or more) in which each processing unit includes one or a plurality of processing lines, each processing line includes an ultraviolet ray irradiating unit, and the number of processing lines of an m-th (m is a natural number smaller than n) stage processing unit is larger than the number of processing lines of an m+1-th stage processing unit; and adjusting section which adjusts an output of an ultraviolet ray irradiating unit provided to a processing unit of a predetermined stage.

An output of an ultraviolet ray irradiating unit provided to a processing unit of a stage other than the predetermined stage is each fixed, and the adjusting section adjusts the output of the let ray irradiating unit provided to the processing unit of the predetermined stage such that a liquid processed in an n-th stage processing unit of a final stage is in a desired processing state.

The liquid processing system has processing units of a plurality of stages, a first stage processing unit has a plurality of water processing lines, and the number of water processing lines decreases as a stage goes to a subsequent stage processing unit.

### EMBODIMENTS

### First Embodiment

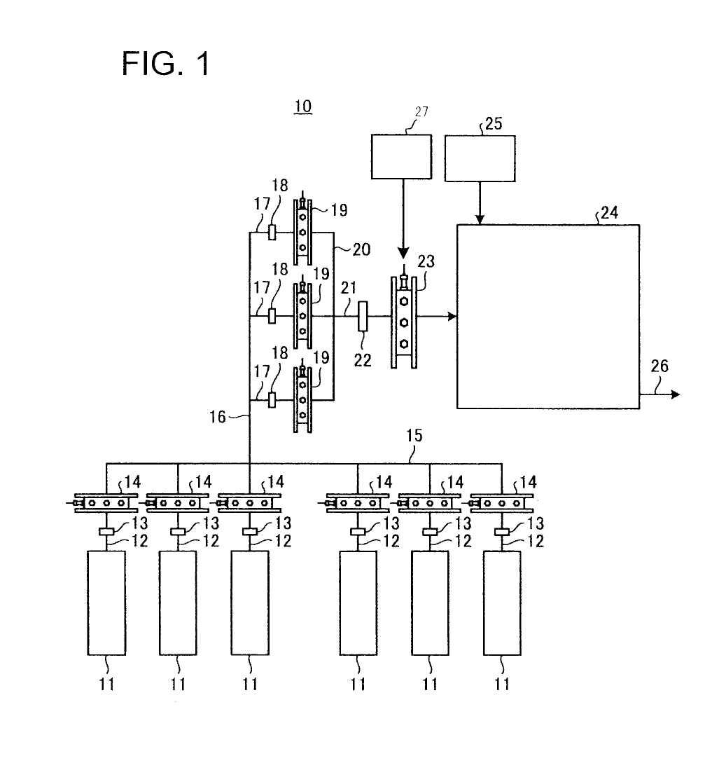

FIG. 1 is a system diagram illustrating a configuration of a water processing system according to the first embodiment.

A water processing system 10 according to the first embodiment uses ground water as water resources. The water processing system 10 has processing units of a plurality of stages. In the first embodiment, the water processing system 10 has processing units of three stages in total.

The water processing system 10 has a plurality of wells 11 from which ground water is pumped up, intake pipes 12 for each well 11, flowmeters (first stage flowmeter) 13 which are provided to the respective intake pipes 12, first stage ultraviolet ray irradiating units 14 which are provided to the intake pipes 12 on the downstream side of the flowmeters 13, a collecting pipe (first stage collecting pipe) 15 which collects the intake pipes 12 on drain outlet sides of the first stage ultraviolet ray irradiating unit 14, and a distributing pipe 16 which is connected to the collecting pipe 15 to be distributed while reducing the number of water processing lines. The collecting pipe 15 collects water processed by each processing line, and the distributing pipe 16 distributes water from the collecting pipe 15, to each processing line leading to a subsequent stage processing unit.

The first stage processing unit has a plurality of water processing lines, and each processing line has the flowmeter 13 and the first stage ultraviolet ray irradiating unit 14. In the first embodiment, the number of water processing lines of the first stage processing unit is six.

The water processing system 10 has a plurality of water pipes 17 which is connected to the distributing pipe 16, flowmeters (second stage flowmeters) 18 which are provided to the respective water pipes 17, second stage ultraviolet ray irradiating units 19 which are provided to the water pipes 17 on a downstream side of the flowmeters 18, and a collecting pipe (second stage collecting pipe) 20 which collects the water pipes 17 on a drain outlet side of the second stage ultraviolet ray irradiating unit 19.

The second stage processing unit has a plurality of water processing lines, and each processing line has the flowmeter 17 and the second stage ultraviolet ray irradiating unit 19. In the first embodiment, the number of water processing lines of the second stage processing unit is three.

The water processing system 10 has a water pipe 21 which is connected to the collecting pipe 20, a flowmeter (third stage flowmeter) 22 which is provided to the water pipe 21, and a third stage ultraviolet ray irradiating unit 23 which is provided to the water pipe 21 on the downstream side of the flowmeter 22.

A third stage processing unit has one water processing line, and this processing line has the flowmeter 21 and the third stage ultraviolet ray irradiating unit 23. In the first embodiment, the number of water processing lines of the third stage processing unit is one.

The number of processing lines of an m-th stage (m is a natural number smaller than n) processing unit is larger than the number of processing lines of an m+1-th stage processing unit. In other words, the number of processing lines of each stage decreases in order of 6>3>1 as the stage number increases.

Further, the water processing system 10 has a clear water reservoir 24 disposed in the downstream of the water pipe 21, a disinfectant injecting device 25 which injects a disinfectant to the clear water reservoir 24, a water pipe 26 for processed water and a controller 27.

According to the above configuration, the third stage ultraviolet ray irradiating unit 23 functions as an ultraviolet ray irradiating unit provided at a predetermined stage. In the present embodiment, the predetermined stage is a final stage.

The controller 27 has a control device such as a CPU, a storage device such as ROM (Read Only Memory) or RAM (Random Access Memory), an external non-volatile storage device, a display device (e.g. an indicator or a liquid crystal panel) which displays a state and an input device such as an operation panel. The controller 27 is, for example, a normal computer.

The controller 27 receives input of output signals from the flowmeters 13, 18 and 22, ultraviolet ray intensity sensors UVS provided to the first stage ultraviolet ray irradiating units 14, the ultraviolet ray intensity sensors UVS provided to the second stage ultraviolet ray irradiating units 19 and the ultraviolet ray intensity sensors UVS provided to the third stage ultraviolet ray irradiating unit 23.

Further, the controller 27 controls the first stage ultraviolet ray irradiating units 14, the second stage ultraviolet ray irradiating units 19 and the third stage ultraviolet ray irradiating unit 23. Hence, the controller 27 functions as adjusting section.

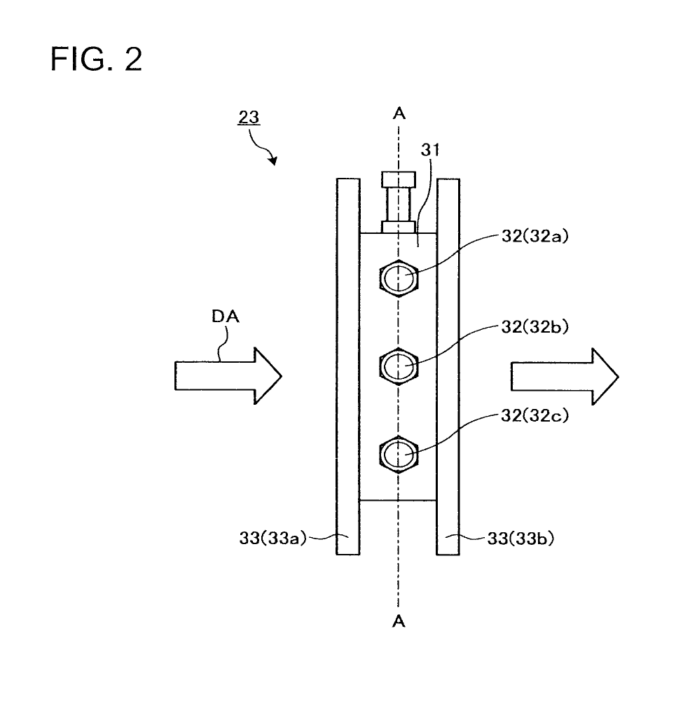

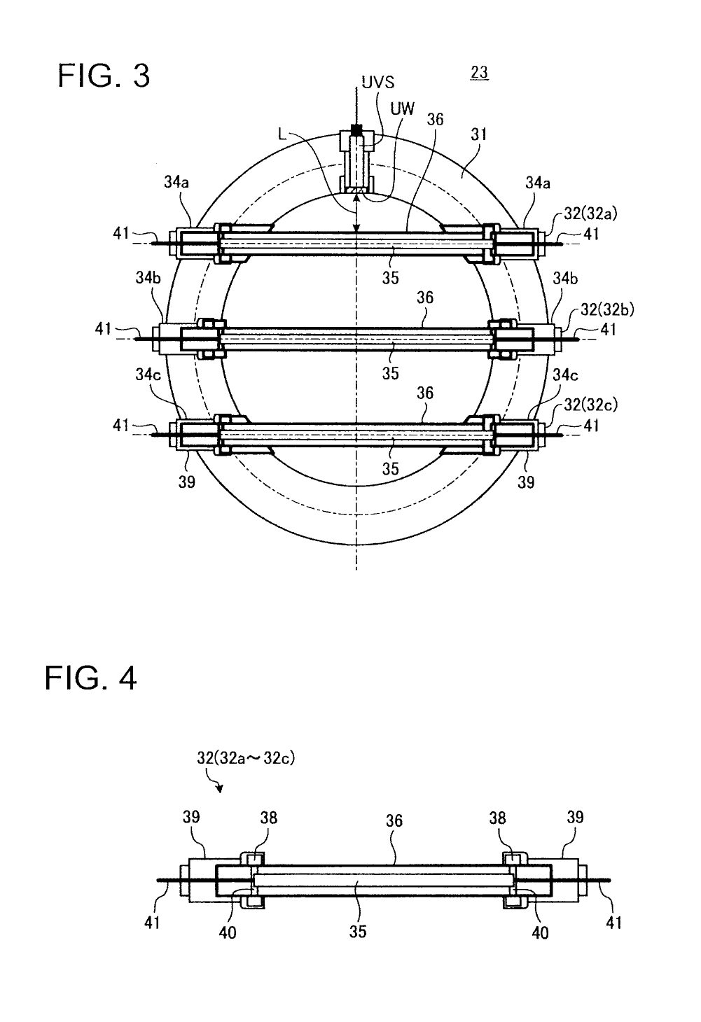

The ultraviolet ray irradiating unit will be described. FIG. 2 is a configuration diagram of the ultraviolet ray irradiating unit. FIG. 3 is an A-A cross-sectional view of the ultraviolet ray irradiating unit in FIG. 2.

The first stage ultraviolet ray irradiating units 14, the second stage ultraviolet ray irradiating units 19 and the third stage ultraviolet ray irradiating unit 23 employ the same configuration. Therefore, the third stage ultraviolet ray irradiating unit 23 will be described instead of describing each ultraviolet ray irradiating unit.

The third stage ultraviolet ray irradiating unit 23 irradiates processing target water with an ultraviolet ray to perform processing of sterilizing, disinfecting and inactivating the processing target water. The third stage ultraviolet ray irradiating unit 23 has a water drum 31, ultraviolet ray irradiating tubes 32 (32a to 32c) and flange joints 33.

The water drum 31 is a member which has a pair of opposing opening portions (a water inlet and a drain outlet) and which is formed in a cylindrical shape, and allows water which is processed to pass toward a direction A (FIG. 2). In the present embodiment, the opening portion on a side to which processing target water flows in is referred to as a water inlet, and the opening portion on a side from which processed water flows out is referred to as a drain outlet. In addition, a case where processing target water flows toward a direction DA will be described with reference to FIG. 2. However, processing target water may flow toward a direction opposite to the direction DA.

Further, in the water drum 31, six through-holes in total having three holes in each opposing side surface (wall surface) of the cylindrical shape are formed. In these six through-holes, bushings 34a, 34b and 34c formed in the through-holes are fixed, and the bushings 34a, 34b and 34c penetrate the water drum 31.

The ultraviolet ray irradiating tube 32 has an ultraviolet lamp 35 and a silica glass tube 36. The third stage ultraviolet ray irradiating unit 23 has the three ultraviolet ray irradiating tubes 32. The respective ultraviolet ray irradiating tubes 32 are described as the ultraviolet ray irradiating tube 32a, the ultraviolet ray irradiating tube 32b and the ultraviolet ray irradiating tube 32c. In addition, in the present embodiment, the third stage ultraviolet ray irradiating unit 23 has the three ultraviolet ray irradiating tubes 32. However, the third stage ultraviolet ray irradiating unit 23 may have one, two, or four or more ultraviolet ray irradiating tubes 32 according to a required ultraviolet ray amount.

The ultraviolet lamp 35 irradiates processing target water which passes through the water drum 31, with ultraviolet rays. The ultraviolet lamp 35 according to the present embodiment has a light emitting portion which emits an ultraviolet ray, and a length (light emission length) of the light emitting portion is in a range of −10% to +10% of the inner diameter of the water drum 31. Further, the ultraviolet lamp 35 emits an ultraviolet ray whose wavelength is in a range of 200 nm to 300 nm. The silica glass tube 36 is made of silica glass, and is a protective tube which accommodates the ultraviolet lamp 35.

The ultraviolet ray irradiating tubes 32a, 32b and 32c are provided in parallel to a plane (a plane including a direction crossing a direction A) which crosses the direction A from the water inlet to the drain outlet. More specifically, the ultraviolet ray irradiating tubes 32a, 32b and 32c are arranged in parallel to each other on the plane orthogonal to the direction A. That is, the ultraviolet ray irradiating tubes 32a, 32b and 32c are vertically arranged in a row with respect to a cross-sectional line A-A as illustrated in FIG. 2.

Further, both end portions of the ultraviolet ray irradiating tubes 32a, 32b and 32c are inserted in bushings 37a, 37b and 37c fixed to the six through-holes provided in the side surfaces of the water drum 31 to oppose to each other, and are attached to the water drum 31.

Furthermore, a triangular groove for an O-ring which is not illustrated is formed near end portions outside the bushings 37a, 37b and 37c. The O-ring is fitted to this triangular groove, and the O-ring is fixed by O-ring weights 38 (see FIG. 4). By this means, the ultraviolet ray irradiating tubes 32a, 32b and 32c are fixed water-tight to the water drum 31.

The flange joints 33 are used to connect the third stage ultraviolet ray irradiating unit 23 with pipes of a water processing facility or the like and other ultraviolet ray irradiating devices. Further, the flange joints 33 are circular disks in which opening portions are formed, and project toward an outside of the opening portion from the periphery of the opening portion of the water drum 31. A flange joint 33a is provided on a water inlet side of the water drum 31. Further, a flange joint 33b is provided on a drain outlet side of the water drum 31. Furthermore, the inner diameter of the flange joint 33 is the same as or smaller than the inner diameter of the water drum 31, and the outer diameter of the flange joint 33 is larger than the outer diameter of the water drum 31.

Next, the ultraviolet ray irradiating tube 32 will be described in detail.

FIG. 4 is a configuration diagram of the ultraviolet ray irradiating tube. The ultraviolet ray irradiating tube 32 has the ultraviolet lamp 35, the silica glass tube 36, the O-ring weights 38, caps 39 and positioning segments 40. Further, as illustrated in FIG. 4, power supply wires 41 are connected to both end portions of the ultraviolet lamp 35.

The O-ring weights 38 weigh down the above O-ring. The positioning segments 40 are attached to both ends of the ultraviolet lamp 35. The positioning segments 40 hold the ultraviolet lamp 35 such that the ultraviolet lamp 35 is positioned at the center of the silica glass tube 36.

The caps 39 are attached to both end portions of the silica glass tube 36. The caps 39 protect the both end portions of the silica glass tubes 36, and prevent an ultraviolet ray irradiated from the ultraviolet lamp 35 from leaking to an outside. In the cap 39, a conductive wire hole through which the wire 41 which supplies power to the ultraviolet lamp 35 passes is formed.

Next, a method of selecting the ultraviolet lamp 35 used for the first stage ultraviolet ray irradiating units 14, the second stage ultraviolet ray irradiating units 19 and the third stage ultraviolet ray irradiating unit 23 will be described.

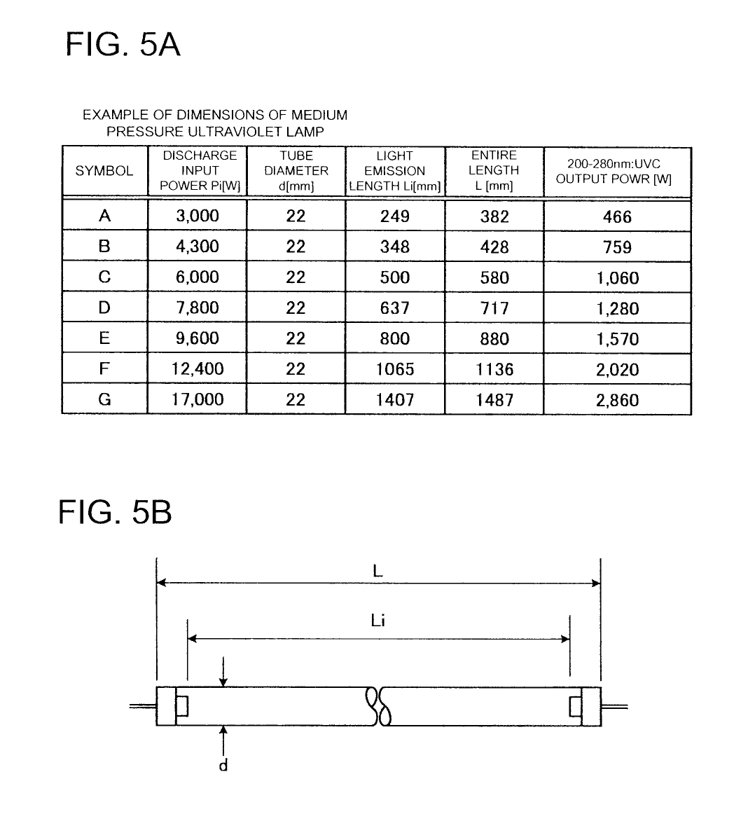

FIG. 5A illustrates an example of dimensions of a medium pressure ultraviolet lamp. FIG. 5B illustrates an external dimension of the ultraviolet lamp. In FIG. 5B, L indicates an entire length of the ultraviolet lamp 35, Li indicates a light emission length and d indicates a tube diameter. The light emission length means the length of the light emitting portion.

Discharge input power Pi (W) takes a value of power supplied to the ultraviolet lamp 35. As illustrated in FIG. 5A, as the discharge input power Pi increases, the light emission length Li becomes long and an ultraviolet ray (200 to 280 nm: UVC) output (W) to be emitted also becomes large.

The diameter of a pipe used in, for example, a water processing facility is selected taking into account a processing flow rate and reduction of pressure loss in the pipe. Generally, the diameter of the pipe is selected such that a water flow velocity is about 2.5 m/sec to 3.0 m/sec.

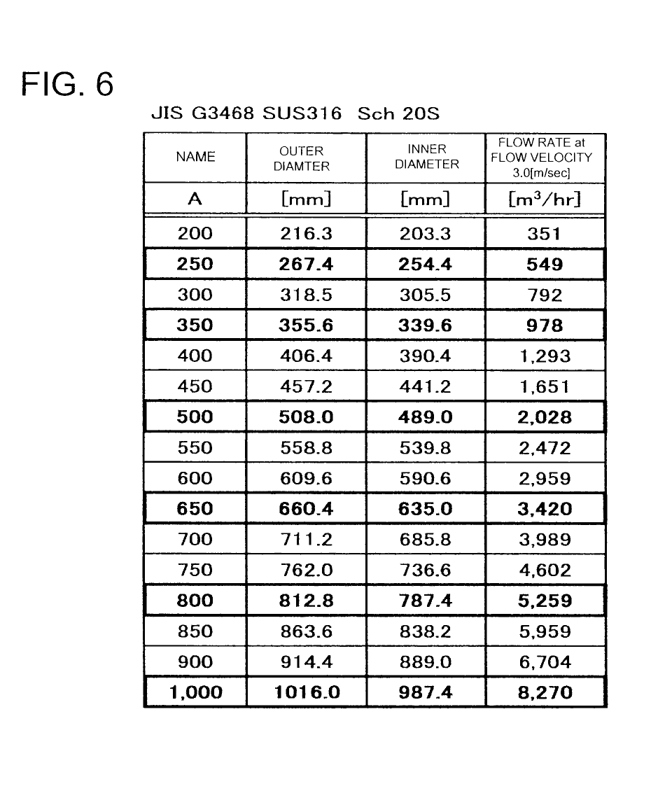

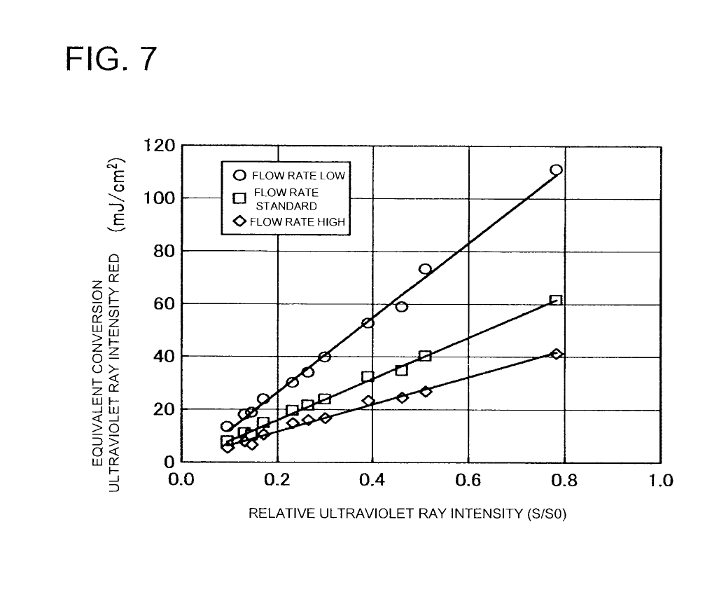

FIG. 6 illustrates relationships between dimensions and flow rates of pipes defined by JIS (Japanese Industrial Standards). The flow rate is a flow rate when a flow velocity is 3.0 m/sec.

The water drums 31 and the ultraviolet lamps 35 of the ultraviolet ray irradiating units 14, 19 and 23 according to the present embodiment are selected with reference to FIGS. 5 and 6. The water drum 31 is selected from a standard article disclosed in FIG. 6. Further, an ultraviolet lamp having the light emission length Li equal to the inner diameter of the water drum 31 is selected as the ultraviolet lamp 35.

A specific example of selection of the ultraviolet lamp 35 will be described. When, for example, the water drum 31 having the same inner diameter as an inner diameter (254.4 mm) of a pipe of a name 250A in FIG. 6 is used, a lamp A having the light emission length Li (249 mm) which is the closest to the inner diameter of the water drum 31 is selected with reference to FIG. 5A.

Further, when, for example, the water drum 31 having the same inner diameter (489.0 mm) of a pipe of a name 500A in FIG. 6 is used, a lamp C having the light emission length Li (500 mm) which is the closest to the inner diameter of the water drum 31 is selected with reference to FIG. 5A.

Furthermore, when, for example, the water drum 31 having the same inner diameter as an inner diameter (987.4 mm) of a pipe of a name 1000A in FIG. 6 is used, a lamp F having the light emission length Li (1065 mm) which is the closest to the inner diameter of the water drum 31 is selected with reference to FIG. 5A.

In the ultraviolet ray irradiating units 14, 19 and 23 according to the present embodiment employing the above configuration, processing target water flows in a water inlet connected with the flange joint 33a and flows in the water drum 31 toward the direction A. Further, processing of sterilizing, disinfecting and inactivating bacteria included in processing target water is performed using ultraviolet light irradiated from the ultraviolet lamps 35 of the ultraviolet ray irradiating tubes 32 arranged in parallel to the plane orthogonal to the direction A. Subsequently, the processed water flows out from the drain outlet connected with the flange joint 33b.

Thus, the water drum 31 which has at both ends the flange joints 33 which have the inner diameters fitting to the inner diameters of the pipes of an existing water processing facility, and which can be connected to pipes of the existing water processing facility are used for the ultraviolet ray irradiating units 14, 19 and 23. Consequently, it is possible to introduce easily the ultraviolet ray irradiating units 14, 19 and 23 in the existing water processing facility. Further, in the ultraviolet ray irradiating units 14, 19 and 23, the ultraviolet ray irradiating tubes 32a, 32b and 32c are arranged in parallel to the plane orthogonal to the direction from the water inlet to the drain outlet. Consequently, a device configuration becomes simple and the ultraviolet ray irradiating tubes 32a, 32b and 32c can be disposed even at narrow places.

Furthermore, the ultraviolet ray irradiating units 14, 19 and 23 can be connected to other ultraviolet ray irradiating units by the flange joints 33. An ultraviolet ray irradiation amount can be adjusted according to the number of ultraviolet ray irradiating units to be connected, and processing target water can be irradiated with a required ultraviolet ray irradiation amount.

Further, the ultraviolet ray irradiating units 14, 19 and 23 use the ultraviolet lamps 35 having the light emission lengths equal to the inner diameters of the water drums 31. Consequently, processing target water is irradiated with ultraviolet rays without waste. Consequently, it is possible to perform efficiently processing of disinfecting (sterilizing) or oxidizing microorganisms, organic materials or processing target inorganic materials included in processing target water.

Next, a positional relationship between an ultraviolet ray intensity measuring window and an ultraviolet lamp will be described.

In the ultraviolet ray irradiating units 14, 19 and 23, the ultraviolet ray intensity sensors UVS which monitor ultraviolet ray irradiation amounts are accommodated in ultraviolet ray intensity measuring windows UW. The measuring window surface is disposed such that a distance L from a measuring window surface to an outer surface of the silica glass tube 36 of the monitoring target ultraviolet ray irradiating tube 32 is about 135 mm. Even when an ultraviolet ray transmittance of processing target water and an output of the ultraviolet lamp 35 change at an arbitrary flow rate, at this distance the relationships between the ultraviolet ray intensities detected by the ultraviolet ray intensity sensors UVS and ultraviolet ray irradiation amounts of the ultraviolet ray irradiating units 14, 19 and 23 can be approximated to a linear equation. Hence, this distance is an optimal position, and was determined based on a test and an analysis result obtained by the inventors.

FIG. 7 illustrates an example of a relationship between an ultraviolet ray intensity and an ultraviolet ray irradiation amount when the distance L between a measuring window surface of an ultraviolet ray intensity measuring window and a silica glass outer surface of an ultraviolet ray irradiating tube is 153 mm.

The horizontal axis is a relative ultraviolet ray intensity (S/S₀). The relative ultraviolet ray intensity (S/S₀) is obtained by dividing an ultraviolet ray intensity S detected by the ultraviolet ray intensity sensor UVS by a reference ultraviolet ray intensity S₀. The reference ultraviolet ray intensity S₀ is an ultraviolet ray intensity when the ultraviolet ray transmittance is 100% and the ultraviolet lamp output is 100%. The vertical axis indicates a conversion equivalent ultraviolet ray irradiation amount RED (Reduction Equivalent Dose) (mJ/cm²). The conversion equivalent ultraviolet ray irradiation amount RED (mJ/cm²) is normally used as an index indicating irradiation performance of an ultraviolet disinfecting device. FIG. 7 also illustrates relationships when a flow rate is a standard flow rate and, in addition, when the flow rate is lower than the standard flow rate and is higher than the standard flow rate.

As illustrated in FIG. 7, by disposing the ultraviolet ray intensity sensors UVS at adequate positions, the conversion equivalent ultraviolet ray irradiation amounts RED of the ultraviolet ray irradiating units 14, 19 and 23 can be calculated based on equation (1) which expresses a relationship between a relative ultraviolet ray intensity (S/S₀) measured by the ultraviolet ray intensity sensors UVS and a flow rate.

$$\begin{matrix}[ Mathematical 1 ] & \\ RED = a \times ( \frac{S}{{S}_{0}} ) \times {( \frac{1}{Q} )}^{b} & ( 1 )\end{matrix}$$

Where

RED: Conversion equivalent ultraviolet ray irradiation amount (mJ/cm²),

S: Ultraviolet ray intensity measurement value (mW/cm²),

S₀: Ultraviolet ray intensity when ultraviolet lamp output control value is 100% (mW/cm²),

Q: Flow rate (m³/d), and

a, b: Coefficients.

Next, a function of the water processing system 10 according to the first embodiment will be described.

A general object of ultraviolet disinfection is to inactivate disinfection target pathogenic microorganisms. An inactivation index is expressed as a Log inactivation rate obtained by performing logarithmic transformation on a residual ratio. When, for example, disinfection target pathogenic microorganisms inhabit at a concentration of 1000 pieces/ml in raw water, and are reduced to 1 piece/ml by irradiation of ultraviolet rays, the inactivation rate is 99.9% and is expressed as 3 Log.

Hence, the water processing system 10 according to the first embodiment sets a processing goal based on the Log inactivation rate of target pathogenic microorganisms, and the ultraviolet ray irradiating units are selected and arranged such that required irradiation performance can be obtained to achieve this goal.

Next, an operation according to the first embodiment will be described.

First, a schematic operation according to the first embodiment will be described.

A processing target of the water processing system 10 is ground water. The pumps which are not illustrated pump ground water from a plurality of wells 11 spotted in an management zone. The flowmeter 13 and the first stage ultraviolet ray irradiating unit 14 are attached to each intake pipe 12. The first stage ultraviolet ray irradiating unit 14 performs first stage ultraviolet ray irradiation on water which passes through the first stage ultraviolet ray irradiating unit 14. That is, initial ultraviolet ray irradiation is performed. Subsequently, water processed by being irradiated with ultraviolet rays by the first stage ultraviolet ray irradiating unit 14 is fed to a water purifying facility.

The water fed to the water purifying facility is once collected by the collecting pipe 15 and moves in the facility. Subsequently, the water is branched to three lines by the distributing pipe 16, and fed to each water pipe 17. The flowmeter 18 and the second stage ultraviolet ray irradiating unit 19 are attached to each water pipe 17. The second stage ultraviolet ray irradiating unit 19 performs second stage ultraviolet ray irradiation on water which passes through the second stage ultraviolet ray irradiating unit 19.

Subsequently, the water which is processed by being irradiated with the ultraviolet rays by the second stage ultraviolet ray irradiating unit 19 is collected to one pipe again by the collecting pipe 20 and is fed to the water pipe 21. The flowmeter 22 and the third stage ultraviolet ray irradiating unit 23 are attached to the water pipe 21. The third stage ultraviolet ray irradiating unit 23 performs third stage ultraviolet ray irradiation on water which passes through the third stage ultraviolet ray irradiating unit 23. That is, final ultraviolet ray irradiation is performed on water. The water which is processed by being irradiated with ultraviolet rays by the third stage ultraviolet ray irradiating unit 23 is fed to the clear water reservoir 24.

Further, a residual disinfectant such as sodium hypochlorite is injected from the disinfectant injecting device 25 to the clear water reservoir 24 to prevent the microorganisms from being bred in the water pipe 26.

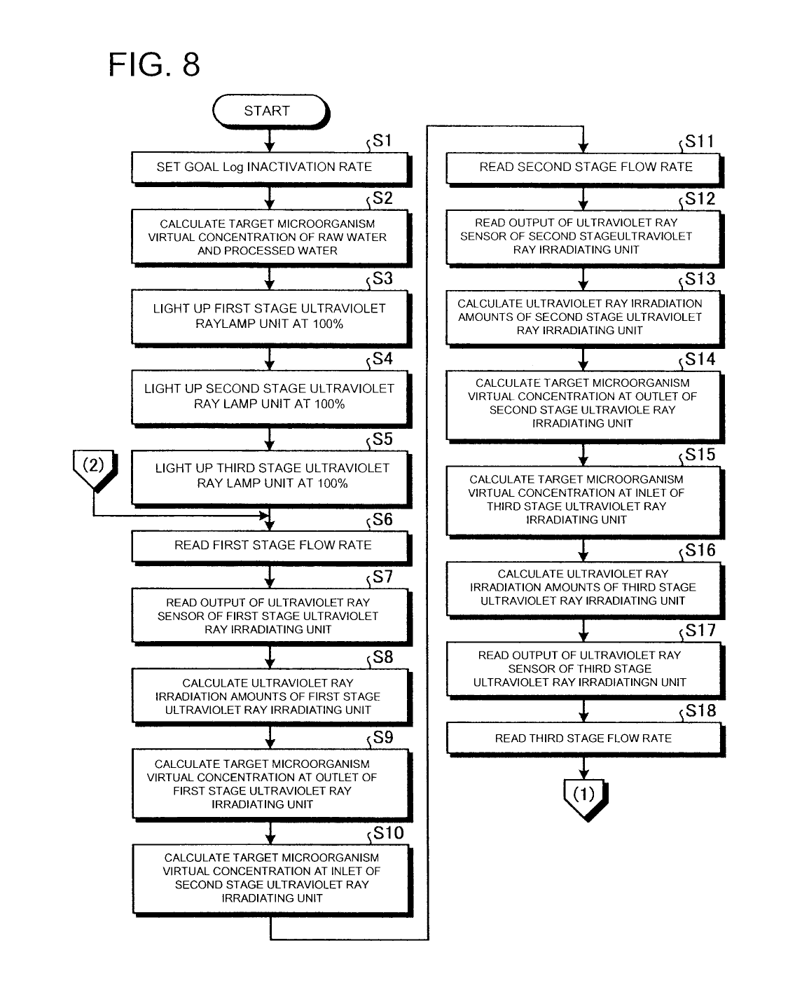

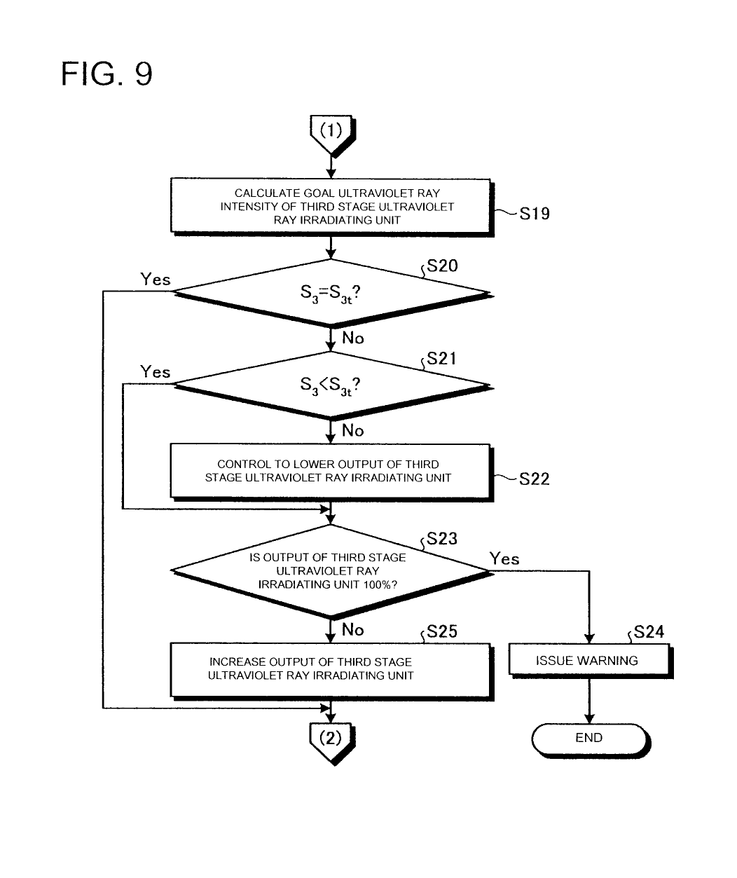

Next, a detailed operation according to the first embodiment will be described. FIG. 8 is a processing flowchart (part 1) of the water processing system according to the first embodiment. FIG. 9 is a processing flowchart (part 2) of the water processing system according to the first embodiment.

First, a goal Log inactivation rate ILog of a disinfection target pathogenic microorganisms is set (step S1). The goal Log inactivation rate is expressed as ILog. A value of ILog is set to, for example, ILog=3 Log.

Next, target microorganism virtual concentrations of processing target water (raw water) and water which is processed (processed water) are calculated (step S2).

$$\begin{matrix} [ Mathematical 2 ] & \\ Raw water virtual concentration {N}_{IN} = {10}^{′} ( pfu \text{/} mL ) & ( 2 ) \\ [ Mathematical 3 ] & \\ Processed water virtual concentration {N}_{OUT} = \frac{{10}_{IN}}{{10}^{I}} ( pfu \text{/} mL ) & ( 3 )\end{matrix}$$

Where the virtual concentration is used in order to calculate an ultraviolet ray irradiation amount of each of the ultraviolet ray irradiating units 14, 19 and 23 in the subsequent steps for convenience sake and is different from an actual microorganism concentration.

Subsequently, the controller 27 lights up each first stage ultraviolet ray irradiating unit 14 at 100% of the ultraviolet lamp output (step S3). That is, each ultraviolet lamp 32 emits light at 100% of the output. The controller 27 lights up each second stage ultraviolet ray irradiating unit 19 at 100% of the ultraviolet lamp (step S4). That is, each ultraviolet lamp 32 emits light at 100% of an output.

Next, the controller 27 lights up the third stage ultraviolet ray irradiating unit 23 at 100% of the ultraviolet lamp output (step S5). That is, each ultraviolet lamp 32 emits light at 100% of the output.

Subsequently, the controller 27 reads first stage flow rates q₁₁, q₁₂, q₁₃, . . . and q₁ₙ, based on outputs of the flowmeter 13 of the respective lines of the first stage (step S6).

Further, the controller 27 reads outputs (ultraviolet ray intensities) S₁₁, S₁₂, S₁₃, . . . and S₁ₙ of the ultraviolet ray intensity sensors UVS attached to the respective first stage ultraviolet ray irradiating units 14 (step S7).

As a result, the controller 27 calculates conversion equivalent ultraviolet ray irradiation amounts (RED) RED₁₁, RED₁₂, RED₁₃, . . . and RED₁ₙ of the respective first stage ultraviolet ray irradiating units 14 based on equation (4) (step S8).

$$\begin{matrix}[ Mathematical 4 ] & \\ {RED}_{1 n} = a 1 \times ( \frac{{S}_{1 n}}{{S}_{0}} ) \times {( \frac{1}{{q}_{1 n}} )}^{b 1} & ( 4 )\end{matrix}$$

Where a1 and b1 are coefficients determined according to characteristics of the first stage ultraviolet ray irradiating unit.

Subsequently, the controller 27 calculates target microorganism virtual concentrations N₁₁, N₁₂, N₁₃, . . . and N₁ₙ at respective outlets of the first stage ultraviolet ray irradiating units 14 based on equation (5) (step S9).

$$\begin{matrix}[ Mathematical 5 ] & \\ {N}_{1 n} = {N}_{IN} / {10}^{\frac{{RED}_{1 n}}{{D}_{0}}} & ( 5 )\end{matrix}$$

Where

D₀: Inactivation velocity constant of target microorganisms (mJ/cm²), and

is an ultraviolet ray irradiation amount required to perform 1 Log inactivation on the target microorganisms.

Next, the controller 27 calculates a target pathogenic microorganism virtual concentration N2 in the distributing pipe 16 based on equation (6) (step S10).

$$\begin{matrix}[ Mathematical 6 ] & \\ {N}_{2} = \frac{{\sum }_{1}^{n} ( {N}_{1 n} \times {q}_{1 n} )}{Q} & ( 6 )\end{matrix}$$

Where Q is a total flow rate and is calculated based on equation (7).

$$\begin{matrix}[ Mathematical 7 ] & \\ Q = {\sum }_{1}^{n} {q}_{1 n} & ( 7 )\end{matrix}$$

Next, the controller 27 reads flow rates q₂₁, q₂₂, . . . and q₂ₙ of the respective water processing lines of the second stage (second stage) (step S11). In parallel to this, the controller 27 reads outputs (ultraviolet ray intensities) S₂₁, S₂₂, . . . and S₂ₙ of the ultraviolet ray intensity sensors UVS attached to the respective second stage ultraviolet ray irradiating units 19 (step S12).

As a result, the controller 27 calculates conversion equivalent ultraviolet ray irradiation amounts RED₂₁, RED₂₂, . . . and RED₂ₙ of the respective second stage ultraviolet ray irradiating units 19 based on equation (8) (step S13).

$$\begin{matrix}[ Mathematical 8 ] & \\ {RED}_{2 n} = a 2 \times ( \frac{{S}_{2 n}}{{S}_{0}} ) \times {( \frac{1}{{q}_{2 n}} )}^{b 2} & ( 8 )\end{matrix}$$

Where a2 and b2 are coefficients determined according to characteristics of the second stage ultraviolet ray irradiating unit.

Subsequently, the controller 27 calculates target microorganism virtual concentrations N₂₁, N₂₂, . . . and N₂ₙ at outlets of the respective second stage ultraviolet ray irradiating units 19 based on equation (9) (step S14).

$$\begin{matrix}[ Mathematical 9 ] & \\ {N}_{2 n} = {N}_{2} / {10}^{\frac{{RED}_{2 n}}{{D}_{0}}} & ( 9 )\end{matrix}$$

Where

D₀: Inactivation velocity constant of target microorganisms (mJ/cm²), and is an ultraviolet ray irradiation amount required to perform 1 Log inactivation on the target microorganisms.

Subsequently, the controller 27 calculates a target pathogenic microorganism virtual concentration N3 in the water pipe 21 based on equation (10) (step S15).

$$\begin{matrix}[ Mathematical 10 ] & \\ {N}_{3} = \frac{{\sum }_{1}^{n} ( {N}_{2 n} \times {q}_{2 n} )}{Q} & ( 10 )\end{matrix}$$

Where Q is a total flow rate and is calculated based on equation (11).

$$\begin{matrix}[ Mathematical 11 ] & \\ Q = {\sum }_{1}^{n} {q}_{2 n} & ( 11 )\end{matrix}$$

Subsequently, the controller 27 calculates a required ultraviolet ray irradiation amount RED₃ₜ of the third stage ultraviolet ray irradiating unit 23 based on equation (12) (step S16).

$$\begin{matrix}[ Mathematical 12 ] & \\ {RED}_{3 t} = {D}_{0} \times Log ( \frac{{N}_{3}}{{N}_{OUT}} ) & ( 12 )\end{matrix}$$

Next, the controller 27 reads an output (ultraviolet ray intensity) S₃ of the ultraviolet ray intensity sensor UVS attached to the third stage ultraviolet ray irradiating unit 23 (step S17). In parallel to this, the controller 27 reads a flow rate q₃ of the water processing line of the third stage (the third stage: the final stage) based on the output of the flowmeter 22 (step S18).

q₃=Q holds.

As a result, the controller 27 calculates a goal ultraviolet ray intensity S3t of the ultraviolet ray intensity sensor UVS attached to the third stage ultraviolet ray irradiating unit 23 based on equation (13) (step S19).

$$\begin{matrix}[ Mathematical 13 ] & \\ {S}_{3 t} = {S}_{0} \times \frac{{RED}_{3 t}}{a 3} \times {Q}^{b 3} & ( 13 )\end{matrix}$$

Where a3 and b3 are coefficients determined according to characteristics of the third stage ultraviolet ray irradiating unit 23.

Subsequently, the controller 27 compares the output S₃ of the ultraviolet ray intensity sensor UVS attached to the third stage ultraviolet ray irradiating unit 23 with the goal ultraviolet ray intensity S₃ₜ, and determines whether or not the output S₃ of the ultraviolet ray intensity sensor UVS coincides with the goal ultraviolet ray intensity S₃ₜ (S₃=S₃ₜ) (step S20). In addition, the coincidence in this case does not mean a strict coincidence in terms of mathematics, and means that a difference between S₃ and S₃ₜ is within an allowable error range.

When it is determined in step S20 that the output S₃ of the ultraviolet ray intensity sensor UVS coincides with the goal ultraviolet ray intensity S₃ₜ (step S20; Yes), the controller 27 moves processing to step S6 again.

When it is determined in step S20 that the output S₃ of the ultraviolet ray intensity sensor UVS does not coincide with the goal ultraviolet ray intensity S₃ₜ (step S20; No), the controller 27 compares the output S₃ of the ultraviolet ray intensity sensor UVS attached to the third stage ultraviolet ray irradiating unit 23 with the goal ultraviolet ray intensity S₃ₜ, and determines whether or not the output S₃ of the ultraviolet ray intensity sensor UVS is smaller than the goal ultraviolet ray intensity S₃ₜ (S₃<S₃ₜ) (step S21).

When it is determined in step S21 that the output S₃ of the ultraviolet ray intensity sensor UVS is smaller than the goal ultraviolet ray intensity S₃ₜ (S₃<S₃ₜ) (step S21; Yes), the controller 27 moves processing to step S23.

When it is determined in step S21 that the output S₃ of the ultraviolet ray intensity sensor UVS is larger than the goal ultraviolet ray intensity S₃ₜ (S₃>S₃ₜ) (step S21; No), the controller 27 lowers an ultraviolet lamp output of the third stage ultraviolet ray irradiating unit 23 by a predetermined unit rate (e.g. 1%) (step 22), and moves processing to step S23.

In step S23, the controller 27 determines whether or not the ultraviolet lamp output of the third stage ultraviolet ray irradiating unit 23 is 100%.

When it is determined in step S23 that the ultraviolet lamp output of the third stage ultraviolet ray irradiating unit 23 is 100% (step S23; Yes), the controller 27 issues a warning that an irradiation amount is insufficient (step S24) and finishes processing.

Meanwhile, when it is determined in step S23 that the ultraviolet lamp output is less than 100% (step S23; No), the controller 27 increases the ultraviolet lamp output of the third stage ultraviolet ray irradiating unit 23 by a predetermined unit rate (e.g. 5%) (step S25), and moves processing to step S6.

In step S22 and step S25, an output of each ultraviolet lamp 32 of the third stage ultraviolet ray irradiating unit 23 is commonly adjusted.

In the present embodiment, a sum of ultraviolet ray irradiation amounts of the first stage, the second stage and the third stage (final stage) only needs to be a required ultraviolet ray irradiation amount or more. Consequently, by fixing outputs of ultraviolet ray irradiating units of processing units of stages other than the predetermined stage and adjusting outputs of the ultraviolet ray irradiating units of a predetermined stage processing unit, it is possible to adjust an ultraviolet ray irradiation amount of the entire system. Consequently, the liquid processing system according to the present embodiment can operate the liquid processing system with high irradiation efficiency and effectively reduce operation cost.

Individual ultraviolet ray irradiating units can be easily disposed at narrow places, and can be easily introduced in an existing facility. Consequently, according to the present embodiment, it is possible to select sizes of ultraviolet ray irradiating units according to a pipe diameter per place at which the ultraviolet ray irradiating units are disposed. Consequently, processing target water is irradiated with all ultraviolet rays emitted from ultraviolet lamps. Consequently, the liquid processing system according to the present embodiment can be operated with higher irradiation efficiency. Further, according to the present embodiment, an expanding pipe and a reducing pipe for adjusting pipe diameters are not required.

At a water purifying plant at which water is taken from a plurality of wells 11, water of a fixed amount is not taken from all wells 11 at all times, and an operation of intermittently taking water is performed frequently according to changes in water amounts, water levels and water quality statuses of the individual wells 11. Even in this case, by setting as the first stage the predetermined stage at which outputs of ultraviolet ray irradiating units are adjusted, and flexibly operating the first stage ultraviolet ray irradiating units to meet pumping statuses of individual pumps, it is possible to realize ultraviolet processing without waste in the entire facility.

### Second Embodiment

Next, the second embodiment will be described.

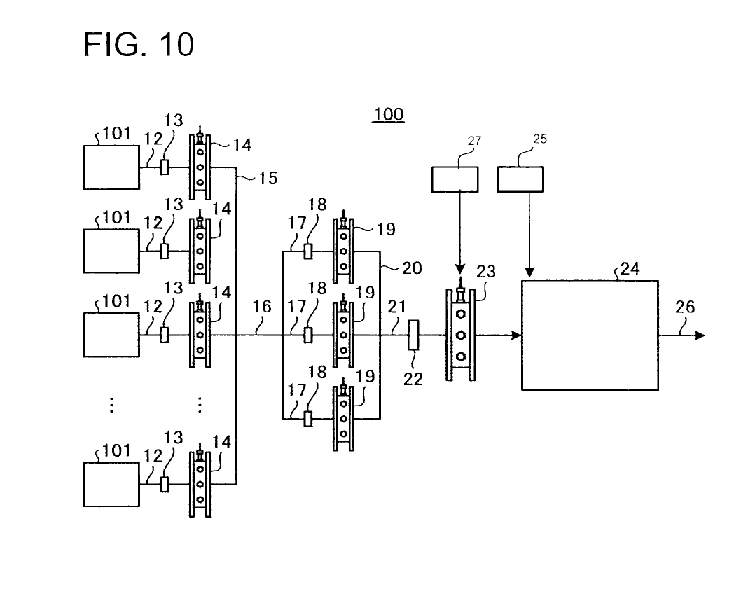

FIG. 10 is a system diagram illustrating a configuration of a water processing system according to the second embodiment. In FIG. 10, the same components as the components in FIG. 1 will be assigned the same reference numerals.

Processing target water which is raw water of a water processing system 100 is individually pumped by pumps which are not illustrated, from a plurality of processing target water tanks 101 whose water quality and water levels are different.

The water processing system 100 has flowmeters (first stage flowmeters) 13 which are provided to respective water pipes 12, first stage ultraviolet ray irradiating units 14 which are provided to the respective water pipes 12 on the downstream side of the flowmeters 13, a collecting pipe (first stage collecting pipe) 15 which collects the water pipes 12, and a distributing pipe 16 which is connected to the collecting pipe 15 to be distributed while reducing the number of water processing lines. The collecting pipe 15 collects water processed by each processing line, and the distributing pipe 16 distributes water from the collecting pipe 15 to each processing line leading to a subsequent stage processing unit.

The first stage processing unit has a plurality of water processing lines, and each processing line has the flowmeter 13 and the first stage ultraviolet ray irradiating unit 14.

Further, the water processing system 100 has a plurality of water pipes 17 which is connected to the distributing pipe 16, flowmeters (second stage flowmeters) 18 which are provided to the respective water pipes 17, second stage ultraviolet ray irradiating units 19 which are provided to the respective water pipes 17 on the downstream side of the flowmeters 18, and a collecting pipe (second stage collecting pipe) 20 which collects the water pipes 17.

The second stage processing unit has a plurality of water processing lines, and each processing line has the flowmeter 17 and the second stage ultraviolet ray irradiating unit 19. In the second embodiment, the number of water processing lines of the second stage processing unit is three.

The water processing system 10 has a water pipe 21 which is connected to the collecting pipe 20, a flowmeter (third stage flowmeter) 22 which is provided to the water pipe 21, and a third stage ultraviolet ray irradiating unit 23 which is provided to the water pipe 21 on the downstream side of the flowmeter 22. The third stage processing unit has one water processing line, and this processing line has the flowmeter 21 and the third stage ultraviolet ray irradiating unit 23. In the first embodiment, the number of water processing lines of the third stage processing unit is one.

Further, the water processing system 10 has a clear water reservoir 24 which is disposed in the downstream of the water pipe 21, a disinfectant injecting device 25 which injects an disinfectant in the clear water reservoir 24, a water pipe 26 and a controller 27.

In the above configuration, the third stage ultraviolet ray irradiating unit 23 functions as an ultraviolet ray irradiating unit provided at a predetermined stage. In the present embodiment, the predetermined stage is the final stage.

Further, the controller 27 receives inputs of output signals from the flowmeters 13, 18 and 22, ultraviolet ray intensity sensors UVS provided to the first stage ultraviolet ray irradiating units 14, the ultraviolet ray intensity sensors UVS provided to the second stage ultraviolet ray irradiating units 19 and the ultraviolet ray intensity sensors UVS provided to the third stage ultraviolet ray irradiating unit 23. Furthermore, the controller 27 controls the first stage ultraviolet ray irradiating units 14, the second stage ultraviolet ray irradiating units 19 and the third stage ultraviolet ray irradiating unit 23.

Next, a function according to the second embodiment will be described.

An ultraviolet ray has a function of decoloring, deodorizing or bleaching processing target water. An object of the water processing system 100 is to dissolve and remove materials which cause coloring or odor of processing target water.

The required ultraviolet ray irradiation amount in the water processing system 100 is expressed as energy dose UV_Dose unlike an ultraviolet ray disinfecting system whose object is disinfection. The energy dose UV_Dose is calculated based on equation (14).

[Mathematical 14]

UV_Dose= I̅_̅{̅V̅}̅×t(mJ/cm²) (14)

Where t indicates a time at which processing target water is irradiated with an ultraviolet ray when passing through an ultraviolet ray irradiating unit, and is calculated based on equation (15).

$$\begin{matrix}[ Mathematical 15 ] & \\ t = \frac{Q}{{A}_{av}} & ( 15 )\end{matrix}$$

Where Aₐᵥ: Average flow path cross-sectional area in ultraviolet ray irradiating unit (m²), and

Q: Flow rate (m³/s).

Further, I_{V} is a volume average ultraviolet ray intensity in an ultraviolet ray irradiating unit, and is calculated based on equation (16).

$$\begin{matrix}[ Mathematical 16 ] & \\ \overline{{I}_{V}} = \frac{{\int }_{V} {I}_{λ} d V}{V} & ( 16 )\end{matrix}$$

Where

I_{λ}: Ultraviolet ray intensity at arbitrary position in ultraviolet ray irradiating unit (mW/cm²), and

V: Internal volume of ultraviolet ray irradiating unit (me).

Hence, the water processing system 100 according to the second embodiment sets a processing goal at a removal rate of a processing target material. The ultraviolet ray irradiating unit is selected and arranged to obtain irradiation performance required to achieve this goal.

Next, a method of operating and controlling the ultraviolet processing system according to the second embodiment will be described.

Where water quality and a water level of processing target water differs per processing target water tank 101. Accordingly, an ultraviolet ray transmittance of processing target water differs per processing target water tank. Further, the energy dose UV_Dose of an ultraviolet ray in an ultraviolet ray irradiating unit, an ultraviolet ray intensity S detected by the ultraviolet ray intensity sensor and a processing flow rate Q are assumed to satisfy equation (17).

$$\begin{matrix}[ Mathematical 17 ] & \\ UV\_Dose = a \times ( \frac{S}{{S}_{0}} ) \times {( \frac{1}{Q} )}^{b} & ( 17 )\end{matrix}$$

Where

UV_Dose: Ultraviolet ray energy dose (mJ/cm²),

S: Ultraviolet ray intensity measurement value (mW/cm²),

S₀: Ultraviolet ray intensity when ultraviolet lamp output control value is 100% (mW/cm²),

Q; Flow rate (m³/d), and

a, b: Coefficients.

Further, a relationship between the removal rate R of a processing target material and the ultraviolet ray energy dose UV_Dose is assumed to be approximated by an exponential equation of equation (18).

$$\begin{matrix}[ Mathematical 18 ] & \\ R = \frac{{C}_{OUT}}{{C}_{IN}} = α \times {UV\_Dose}^{β} & ( 18 )\end{matrix}$$

Where

C_{IN}: Processing target material concentration of raw water (mg/L),

C_{OUT}: Processing target material concentration of processed water (mg/L), and

α, β: Coefficients determined according to characteristics of ultraviolet ray irradiating unit.

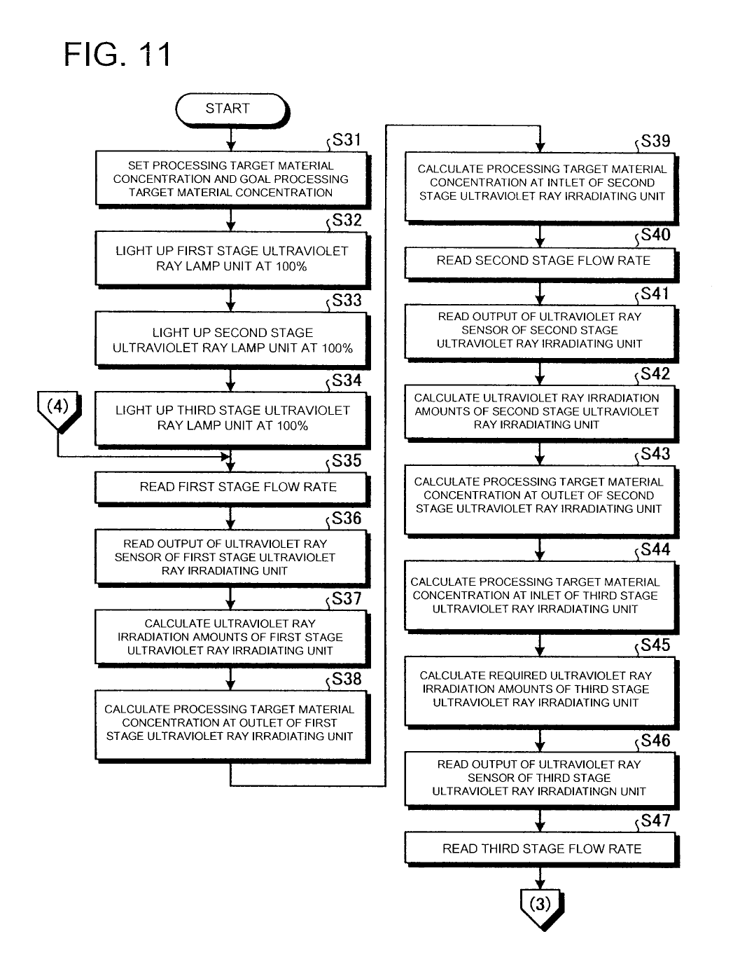

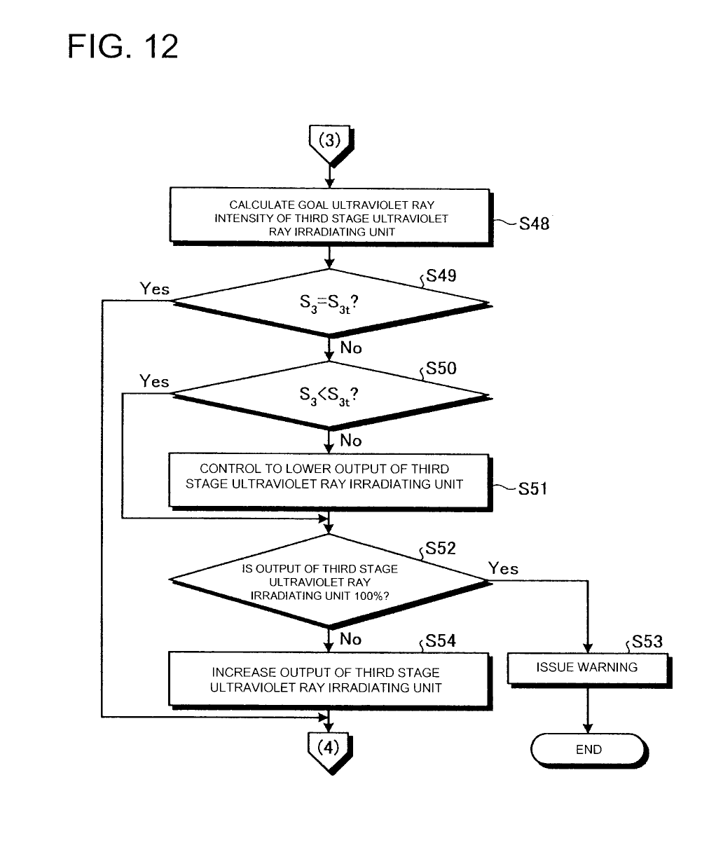

FIG. 11 is a processing flowchart (part 1) of the water processing system according to the second embodiment. FIG. 12 is a processing flowchart (part 2) of the water processing system according to the second embodiment.

First, the controller 27 sets the processing target material concentration C_{IN} of raw water and the goal processing target material concentration C_{OUT} of finally processed water (step S31).

Subsequently, the controller 27 lights up each first stage ultraviolet ray irradiating unit 14 at 100% of an ultraviolet lamp output (step S32). That is, each ultraviolet lamp emits light at 100% of the output.

The controller 27 lights up each second stage ultraviolet ray irradiating unit 19 at 100% of the ultraviolet lamp (step S33). That is, each ultraviolet lamp emits light at 100% of an output.

Further, the controller 27 lights up the third stage ultraviolet ray irradiating unit 23 at 100% of the ultraviolet lamp output (step S34). That is, each ultraviolet lamp emits light at 100% of the output.

Next, the controller 27 reads first stage flow rates q₁₁, q₁₂, q₁₃, . . . and q₁ₙ based on output signals of the flowmeters 13 (step S35). Further, the controller 27 reads outputs (ultraviolet ray intensities) S₁₁, S₁₂, S₁₃, . . . and S₁ₙ of the ultraviolet ray intensity sensors UVS attached to the first stage ultraviolet ray irradiating units 14 (step S36).

Furthermore, the controller 27 calculates ultraviolet ray irradiation amounts UV_Dose₁₁, UV_Dose₁₂, UV_Dose₁₃, . . . and UV_Dose₁ₙ of the respective first stage ultraviolet ray irradiating units 14 based on equation (19) (step S37).

$$\begin{matrix}[ Mathematical 19 ] & \\ {UV\_Dose}_{1 n} = a 1 \times ( \frac{{S}_{1 n}}{{S}_{0}} ) \times {( \frac{1}{{q}_{1 n}} )}^{b 1} & ( 19 )\end{matrix}$$

Where a1 and b1 are coefficients determined according to characteristics of the first stage ultraviolet ray irradiating unit.

Next, the controller 27 calculates processing target material concentrations C₁₁, C₁₂, C₁₃, . . . and C₁ₙ at outlets of the first stage ultraviolet ray irradiating units 14 based on equation (20) (step S38).

[Mathematical 20]

C₁ₐ=C_{IN}×α₁×UV_Dose₁ₐ^{β}^{₁} (20)

Where α₁ and β₁ are coefficients determined according to characteristics of the first stage ultraviolet ray irradiating unit.

Subsequently, the controller 27 calculates a processing target material concentration in the distributing pipe 16 based on equation (21) (step S39).

$$\begin{matrix}[ Mathematical 21 ] & \\ {C}_{2} = \frac{{\sum }_{1}^{n} ( {C}_{1 n} \times {q}_{1 n} )}{Q} & ( 21 )\end{matrix}$$

Where Q is a total flow rate and is calculated based on equation (22).

$$\begin{matrix}[ Mathematical 22 ] & \\ Q = {\sum }_{1}^{n} {q}_{1 n} & ( 22 )\end{matrix}$$

Subsequently, the controller 27 reads second stage flow rates q₂₁, q₂₂, . . . and q₂ₙ based on output signals of the flowmeters 18 (step S40). Further, the controller 27 reads outputs (ultraviolet ray intensities) S₂₁, S₂₂, . . . and S₂ₙ, of the ultraviolet ray intensity sensors UVS attached to the respective second stage ultraviolet ray irradiating units 19 (step S41).

Furthermore, the controller 27 calculates ultraviolet ray irradiation amounts UV_Dose₂ₗ, UV_Dose₂₂, . . . and UV_Dose₂ₙ of the respective second stage ultraviolet ray irradiating units 19 based on equation (23) (step S42).

$$\begin{matrix}[ Mathematical 23 ] & \\ {UV\_Dose}_{2 n} = a 2 \times ( \frac{{S}_{2 n}}{{S}_{0}} ) \times {( \frac{1}{{q}_{2 n}} )}^{b 2} & ( 23 )\end{matrix}$$

Where a2 and b2 are coefficients determined according to characteristics of the first stage ultraviolet ray irradiating unit.

Further, the controller 27 calculates processing target material concentrations C₂₁, C₂₂, . . . and C₂ₙ at respective outlets of the second stage ultraviolet ray irradiating units 19 based on equation (24) (step S43).

[Mathematical 24]

C₂ₙ=C₂×α₂×UV_Dose₂ₙ^{β}^{₂} (24)

Where α₂ and β₂ are coefficients determined according to characteristics of the second stage ultraviolet ray irradiating unit.

Subsequently, the controller 27 calculates the processing target material concentration C3 in the water pipe 21 based on equation (25) (step S44).

$$\begin{matrix}[ Mathematical 25 ] & \\ {C}_{3} = \frac{{\sum }_{1}^{n} ( {C}_{2 a} \times {q}_{2 n} )}{Q} & ( 25 )\end{matrix}$$

Where Q is a total flow rate and is calculated based on equation (26).

$$\begin{matrix}[ Mathematical 26 ] & \\ Q = {\sum }_{1}^{n} {q}_{2 n} & ( 26 )\end{matrix}$$

Further, the controller 27 calculates a required ultraviolet ray irradiation amount (UV_Dose₃ₜ) of the third stage ultraviolet ray irradiating unit 23 based on equation (27) (step S45).

$$\begin{matrix}[ Mathematical 27 ] & \\ {UV\_Dose}_{3 t} = {( \frac{{C}_{OUT}}{α \times {C}_{3}} )}^{- β} & ( 27 )\end{matrix}$$

Further, the controller 27 reads the output (ultraviolet ray intensity) S₃ of the ultraviolet ray intensity sensor UVS attached to the third stage ultraviolet ray irradiating units 23 (step S46). Furthermore, the controller 27 reads a third stage flow rate q₃ from the flowmeter 22 (step S47).

q₃=Q holds.

Next, the controller 27 calculates a goal ultraviolet ray intensity of the ultraviolet ray intensity sensor UVS attached to the third stage ultraviolet ray irradiating unit 23 based on equation (28) (step S48).

$$\begin{matrix}[ Mathematical 28 ] & \\ {S}_{3 t} = {S}_{0} \times \frac{{UV\_Dose}_{3 t}}{a 3} \times {Q}^{b 3} & ( 28 )\end{matrix}$$

Where a3 and b3 are coefficients determined according to characteristics of the third stage ultraviolet ray irradiating unit.

Subsequently, the controller 27 compares the output S₃ (=detected ultraviolet ray intensity) of the ultraviolet ray intensity sensor UVS attached to the third stage ultraviolet ray irradiating unit 23 with the goal ultraviolet ray intensity S₃ₜ, and determines whether or not the output S₃ of the ultraviolet ray intensity sensor UVS coincides with the goal ultraviolet ray intensity S₃ₜ (S₃=S₃ₜ) (step S49). In addition, the coincidence in this case means that a difference between S₃ and S₃ₜ is within an allowable error range, and does not mean a strict coincidence in terms of mathematics.

When it is determined in step S49 that the output S₃ of the ultraviolet ray intensity sensor UVS coincides with the goal ultraviolet ray intensity S₃ₜ (step S49; Yes), the controller 27 moves processing to step S35.

When it is determined in step S49 that the output S₃ of the ultraviolet ray intensity sensor UVS does not coincide with the goal ultraviolet ray intensity S₃ₜ (step S49; No), the controller 27 compares the output S₃ of the ultraviolet ray intensity sensor UVS attached to the third stage ultraviolet ray irradiating unit 23 with the goal ultraviolet ray intensity S₃ₜ, and determines whether or not the output S₃ of the ultraviolet ray intensity sensor UVS is smaller than the goal ultraviolet ray intensity S₃ₜ (S₃<S₃ₜ) (step S50).

When it is determined in step S50 that the output S₃ of the ultraviolet ray intensity sensor UVS is larger than the goal ultraviolet ray intensity S₃ₜ (S₃>S₃ₜ) (step S50; No), the controller 27 lowers the ultraviolet lamp output of the third stage ultraviolet ray irradiating unit 23 (step S51), and moves processing to step S52.

When it is determined in step S50 that the output S₃ of the ultraviolet ray intensity sensor UVS is smaller than the goal ultraviolet ray intensity S₃ₜ (S₃<S₃ₜ) (step S50; Yes), the controller 27 moves processing to step S52.

In step S52, the controller 27 determines whether or not the ultraviolet lamp output of the third stage ultraviolet ray irradiating unit 23 is 100%.

When it is determined in step S52 that the ultraviolet lamp output is 100% (step S52; Yes), the controller 27 issues a warning that an irradiation amount is insufficient (step S53) and finishes processing.

When it is determined in step S52 that the ultraviolet lamp output is less than 100% (step S52; No), the controller 27 increases the ultraviolet lamp output of the third stage ultraviolet ray irradiating unit 23 by a predetermined amount (step S54), and moves processing to step S35.

In step S51 and step S54, an output of each ultraviolet lamp 32 of the third stage ultraviolet ray irradiating unit 23 is adjusted.

Next, an effect according to the second embodiment will be described.

According to the second embodiment, a sum of ultraviolet ray irradiation amounts of the first stage, the second stage and the third stage only needs to be required ultraviolet irradiation ray irradiation. Consequently, by fixing outputs of ultraviolet ray irradiating units of processing units of stages other than the predetermined stage and adjusting outputs of the ultraviolet ray irradiating units of a predetermined stage processing unit, it is possible to adjust an ultraviolet ray irradiation amount of the entire system. Consequently, the liquid processing system according to the present embodiment can operate the liquid processing system with high irradiation efficiency and effectively reduce operation cost.

Individual ultraviolet ray irradiating units can be easily disposed at narrow places, and can be easily introduced in an existing facility. Consequently, according to the present embodiment, it is possible to select sizes of ultraviolet ray irradiating units according to a pipe diameter per place at which the ultraviolet ray irradiating units are disposed. Consequently, processing target water is irradiated with all ultraviolet rays emitted from ultraviolet lamps. Consequently, the liquid processing system according to the present embodiment can operate with high irradiation efficiency. Further, according to the present embodiment, an expanding pipe and a reducing pipe for adjusting pipe diameters are not required.

In a water processing system at which water is taken from a plurality of processing target tanks, water of a fixed amount is not taken from all processing target water tanks at all times, and an operation of intermittently taking water is performed frequently according to changes in water amounts, water levels and water quality statuses of the individual processing target water tanks. Even in this case, by setting as the first stage the predetermined stage at which outputs of ultraviolet ray irradiating units are adjusted, and flexibly operating the first stage ultraviolet ray irradiating units to meet pumping statuses of individual pumps, it is possible to realize ultraviolet processing without waste in the entire facility.

### Third Embodiment

Next, a liquid processing system according to the third embodiment will be described. A configuration of a water processing system which is the liquid processing system according to the third embodiment is the same as that in the first embodiment. However, in the third embodiment, first ultraviolet ray irradiating units, second ultraviolet ray irradiating violet ray irradiating units and a third stage ultraviolet ray irradiating unit are controlled by a method of operating and controlling an ultraviolet disinfecting system. In the first embodiment, in the ultraviolet disinfecting system configured to have a plurality of stages, a previous stage ultraviolet ray irradiating unit is operated at 100% of an output, and a lamp output is controlled based on irradiation results of preceding stages by a final stage ultraviolet ray irradiating unit.

Next, an operation according to the third embodiment will be described.

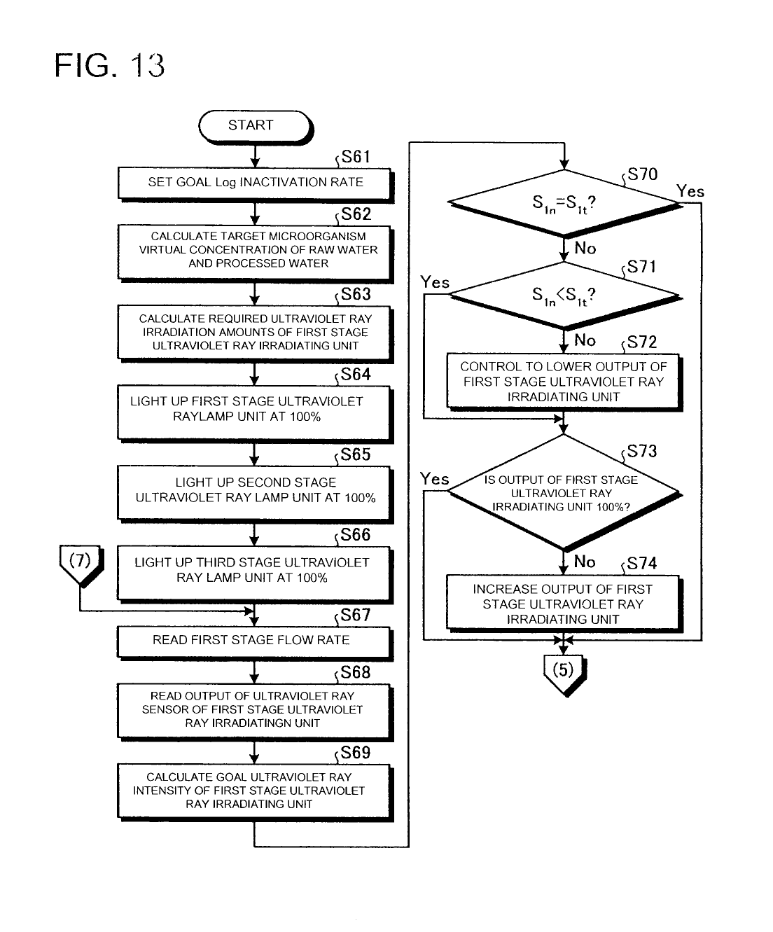

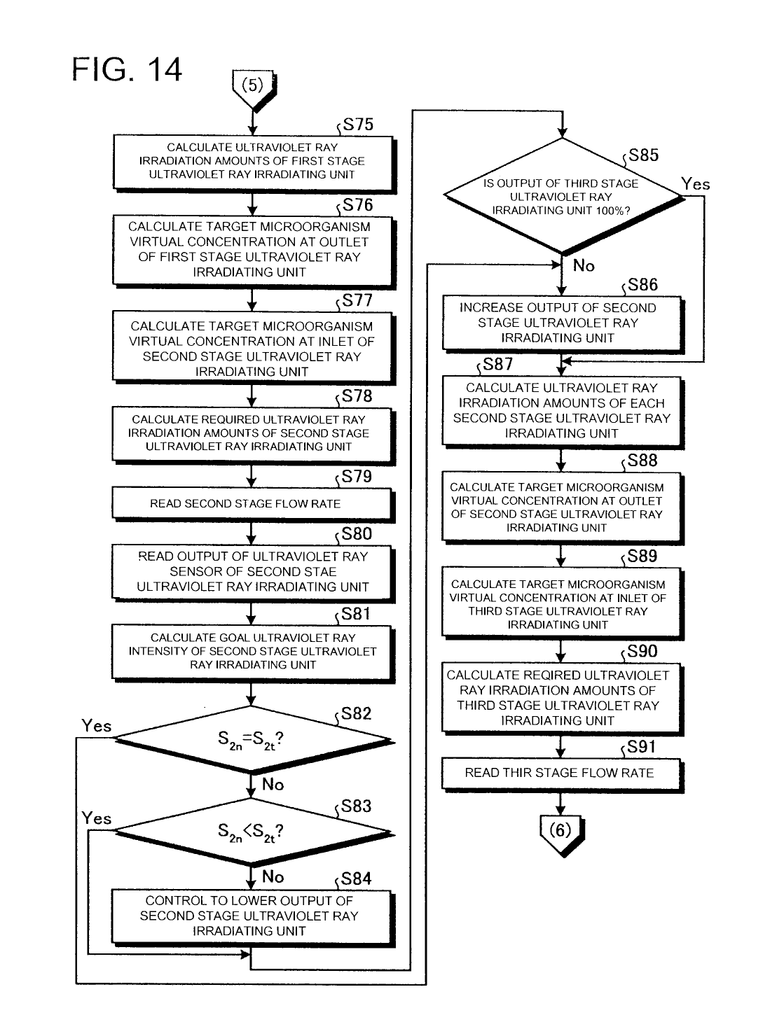

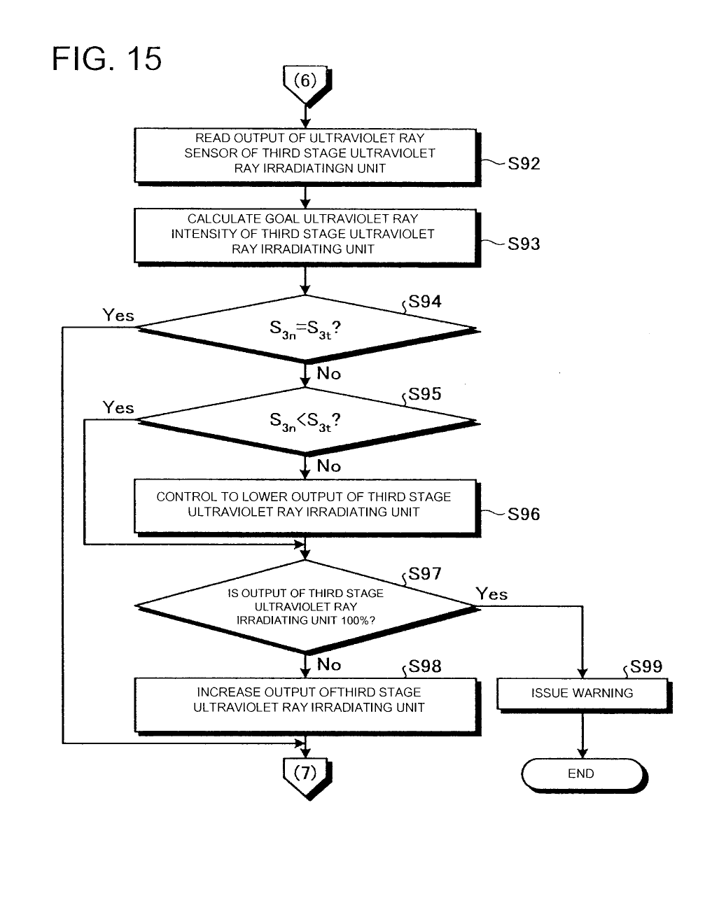

FIG. 13 is a processing flowchart (part 1) of the water processing system according to the third embodiment. FIG. 14 is a processing flowchart (part 2) of the water processing system according to the third embodiment. FIG. 15 is a processing flowchart (part 3) of the water processing system according to the third embodiment.

First, a controller 27 sets a goal Log inactivation rate ILog of a disinfection target pathogenic microorganisms (step S61). For example, the controller 27 sets ILog to 3 Log.

Next, the controller 27 calculates a target microorganism virtual concentration N_{IN} of raw water (processing target water) and a target microorganism virtual concentration N_{OUT} of processed water (water which is processed) based on equation (29) and equation (30) (step S62).

$$\begin{matrix} [ Mathematical 29 ] & \\ Raw water virtual concentration {N}_{IN} = {10}^{I} ( pfu \text{/} mL ) & ( 29 ) \\ [ Mathematical 30 ] & \\ Processed water virtual concentration {N}_{OUT} = \frac{{10}_{IN}}{{10}^{I}} ( pfu \text{/} mL ) & ( 30 )\end{matrix}$$

Where the virtual concentration is used in order to calculate an ultraviolet ray irradiation amount of each of ultraviolet ray irradiating units 14, 19 and 23 in the subsequent steps for convenience sake and is different from an actual microorganism concentration of processing target water.

Subsequently, the controller 27 calculates a required ultraviolet ray irradiation amount (RED) of the first stage ultraviolet ray irradiating unit 14 based on equation (31) (step S63).

$$\begin{matrix}[ Mathematical 31 ] & \\ {RED}_{1 t} = {D}_{0} \times Log ( \frac{{N}_{IN}}{{N}_{OUT}} ) & ( 31 )\end{matrix}$$

Next, the controller 27 lights up each first stage ultraviolet ray irradiating unit 14 at 100% of the ultraviolet lamp output (step S64). That is, each ultraviolet lamp 32 emits light at 100% of the output.

Further, the controller 27 lights up each second stage ultraviolet ray irradiating unit 19 at 100% of the ultraviolet lamp output (step S65). That is, each ultraviolet lamp 32 emits light at 100% of the output.

Further, the controller 27 lights up each third stage ultraviolet ray irradiating unit 23 at 100% of the ultraviolet lamp output (step S66). That is, each ultraviolet lamp 32 emits light at 100% of the output.

Subsequently, the controller 27 reads first stage flow rates q₁₁, q₁₂, . . . and q₁ₙ based on outputs of flowmeters 13 (step S67).

Further, the controller 27 reads outputs (ultraviolet ray intensities) S₁₁, S₁₂, . . . and S₁ₙ of the ultraviolet ray intensity sensors UVS attached to the first stage ultraviolet ray irradiating units 14 (step S68).

Furthermore, the controller 27 calculates a goal ultraviolet ray intensity S₁ₜ of the ultraviolet ray intensity sensor UVS attached to the first stage ultraviolet ray irradiating units 14 based on equation (32) (step S69).

$$\begin{matrix}[ Mathematical 32 ] & \\ {S}_{1 t} = {S}_{0} \times \frac{{RED}_{1 t}}{a 1} \times {Q}^{b 1} & ( 32 )\end{matrix}$$

Where a1 and b1 are coefficients determined according to characteristics of the first stage ultraviolet ray irradiating unit.

Further, the controller 27 compares the output S₁ₙ of the ultraviolet ray intensity sensor UVS attached to the first stage ultraviolet ray irradiating unit 14 with the goal ultraviolet ray intensity S₁ₜ, and determines whether or not the output S₁ₙ of the ultraviolet ray intensity sensor UVS coincides with the goal ultraviolet ray intensity S₁ₜ (S₁ₙ=S₁ₜ) (step S70). Also in this case, the coincidence does not mean a strict coincidence in terms of mathematics, and means that a difference between S₁ and S₁ₜ is within an allowable error range.

When it is determined in step S70 that the output S₁ₙ of the ultraviolet ray intensity sensor UVS coincides with the goal ultraviolet ray intensity S₁ₜ (step S70; Yes), the controller 27 moves processing to step S75.

When it is determined in step S70 that the output S₁ₙ of the ultraviolet ray intensity sensor UVS does not coincide with the goal ultraviolet ray intensity S₁ₜ (step S70; No), the controller 27 compares the output S₁ₙ of the ultraviolet ray intensity sensor UVS attached to the first stage ultraviolet ray irradiating unit 14 with the goal ultraviolet ray intensity S₁ₜ, and determines whether or not the output S₁ₙ of the ultraviolet ray intensity sensor UVS is smaller than the goal ultraviolet ray intensity S₁ₜ (S₁ₙ<S₁ₜ) (step S71).

When it is determined in step S71 that the output S₁ₙ of the ultraviolet ray intensity sensor UVS is larger than the goal ultraviolet ray intensity S₁ₜ (S₁ₙ>S₁ₜ) (step S71; No), the controller 27 lowers the ultraviolet lamp output of the first stage ultraviolet ray irradiating unit 14 (step S72), and moves processing to step S73.

When it is determined in step S71 that the output S₁ₙ of the ultraviolet ray intensity sensor UVS is smaller than the goal ultraviolet ray intensity S₁ₜ (S₁ₙ<S₁ₜ) (step S71; Yes), the controller 27 moves processing to step s73.

In step S73, the controller 27 determines whether or not the ultraviolet lamp output of the first stage ultraviolet ray irradiating unit 14 is 100%.

When it is determined in step s73 that the ultraviolet lamp output of the first stage ultraviolet ray irradiating unit 14 is 100% (step S73; Yes), the controller 27 moves processing to step S75.

When it is determined in step S73 that the ultraviolet lamp output of the first stage ultraviolet ray irradiating unit 14 is less than 100% (step S73; No), the controller 27 increases the ultraviolet lamp output of the first stage ultraviolet ray irradiating unit 14 by a predetermined amount (step S74), and moves processing to step S75.

The processing in step S69 to step S74 is performed on each first stage ultraviolet ray irradiating unit 14. Further, in step S72 and step S74, an output of each ultraviolet lamp 32 of the first stage ultraviolet ray irradiating unit 14 is adjusted.

Subsequently, the controller 27 calculates conversion equivalent ultraviolet ray irradiation amount RED₁₁, RED₁₂, RED₁₃, . . . and RED₁ₙ, of the respective first stage ultraviolet ray irradiating units 14 based on equation (33) (step S75).

$$\begin{matrix}[ Mathematial 33 ] & \\ {RED}_{1 n} = a 1 \times ( \frac{{S}_{1 n}}{{S}_{0}} ) \times {( \frac{1}{{q}_{1 n}} )}^{b 1} & ( 33 )\end{matrix}$$

Where a1 and b1 are coefficients determined according to characteristics of the first stage ultraviolet ray irradiating unit.

Next, the controller 27 calculates target microorganism virtual concentrations N₁₁, N₁₂, N₁₃, . . . and N₁ₙ at outlets of the first stage ultraviolet ray irradiating units 14 based on equation (34) (step S76).

$$\begin{matrix}[ Mathematical 34 ] & \\ {N}_{1 n} = \frac{{N}_{IN}}{{10}^{\frac{{RED}_{1 n}}{{D}_{0}}}} & ( 34 )\end{matrix}$$

Where

D₀: Inactivation velocity constant of target microorganisms (mJ/cm²), and is an ultraviolet ray irradiation amount required to perform 1 Log inactivation on the target microorganisms.

Subsequently, the controller 27 calculates a target pathogenic microorganism virtual concentration N₂ in a distributing pipe 16 based on equation (35) (step S77).

$$\begin{matrix}[ Mathematical 35 ] & \\ {N}_{2} = \frac{{\sum }_{1}^{n} ( {N}_{1 n} \times {q}_{1 n} )}{Q} & ( 35 )\end{matrix}$$

Where Q is a total flow rate and is calculated based on equation (36).

$$\begin{matrix}[ Mathematical 36 ] & \\ Q = {\sum }_{1}^{n} {q}_{1 n} & ( 36 )\end{matrix}$$

Next, the controller 27 calculates a required ultraviolet ray irradiation amount RED₂ₜ of the second stage ultraviolet ray irradiating unit 19 based on equation (37) (step S78).

$$\begin{matrix}[ Mathematical 37 ] & \\ {RED}_{2 t} = {D}_{0} \times Log ( \frac{{N}_{2}}{{N}_{OUT}} ) & ( 37 )\end{matrix}$$

Subsequently, the controller 27 reads second stage flow rates q₂₁, q₂₂, . . . and q₂ₙ based on outputs of flowmeters 18 (step S79).

Further, the controller 27 reads outputs (ultraviolet ray intensities) S₂₁, S₂₂, . . . and S₂ₙ of the ultraviolet ray intensity sensors UVS attached to the respective second stage ultraviolet ray irradiating units 19 (step S80).

In parallel to this, the controller 27 calculates a goal ultraviolet ray intensity S₂ₜ of the ultraviolet ray intensity sensor UVS attached to the second stage ultraviolet ray irradiating unit 19 based on equation (38) (step S81).

$$\begin{matrix}[ Mathematical 38 ] & \\ {S}_{2 t} = {S}_{0} \times \frac{{RED}_{2 t}}{a 2} \times {Q}^{b 2} & ( 38 )\end{matrix}$$

Where a2 and b2 are coefficients determined according to characteristics of the second stage ultraviolet ray irradiating unit.

Next, the controller 27 compares the output S₂ₙ of the ultraviolet ray intensity sensor UVS attached to the second stage ultraviolet ray irradiating unit 19 with the goal ultraviolet ray intensity S₂ₜ, and determines whether or not the output S₂ₙ of the ultraviolet ray intensity sensor UVS coincides with the goal ultraviolet ray intensity S₂ₜ (S₂ₙ=S₂ₜ) (step S82).

When it is determined in step S82 that the output S₂ₙ of the ultraviolet ray intensity sensor UVS coincides with the goal ultraviolet ray intensity S₂ₜ (step S82; Yes), the controller 27 moves processing to step S86.

When it is determined in step S82 that the output S₂ₙ of the ultraviolet ray intensity sensor UVS does not coincide with the goal ultraviolet ray intensity S₂ₜ (step S82; No), the controller 27 compares the output S₂ₙ of the ultraviolet ray intensity sensor UVS attached to the second stage ultraviolet ray irradiating unit 19 with the goal ultraviolet ray intensity S₂ₜ, and determines whether or not the output S₂ₙ of the ultraviolet ray intensity sensor UVS is smaller than the goal ultraviolet ray intensity S₂ₜ (S₂ₙ<S₂ₜ) (step S83).

When it is determined in step S83 that the output S₂ₙ of the ultraviolet ray intensity sensor UVS is larger than the goal ultraviolet ray intensity S₂ₜ (step S83; No), the controller 27 lowers the ultraviolet lamp output of the second stage ultraviolet ray irradiating unit 19 by a predetermined amount (step S84), and moves processing to step S85.

Meanwhile, when it is determined in step S83 that an actual ultraviolet ray intensity corresponding to the output S₂ₙ of the ultraviolet ray intensity sensor UVS is smaller than the goal ultraviolet ray intensity S₂ₜ (in case of S₂ₙ<S₂ₜ) (step S83; Yes), the controller 27 moves processing to step S85.

In step S85, the controller 27 determines whether or not the ultraviolet lamp output of the second stage ultraviolet ray irradiating unit 19 is 100%.

When it is determined in step S85 that the ultraviolet lamp output of the second stage ultraviolet ray irradiating unit 19 is 100% (step S85; Yes), the controller 27 moves processing to step S87.

When it is determined in step S85 that the ultraviolet lamp output of the second stage ultraviolet ray irradiating unit 19 is less than 100% (step S85; No), the controller 27 increases the ultraviolet lamp output of the second stage ultraviolet ray irradiating unit 19 by a predetermined amount (step S86) and calculates conversion equivalent ultraviolet ray irradiation amounts RED₂₁, RED₂₂, . . . and RED₂ₙ of the respective second stage ultraviolet ray irradiating units 19 based on equation (39) (step S87).

$$\begin{matrix}[ Mathematical 39 ] & \\ {RED}_{2 a} = a 2 \times ( \frac{{S}_{2 a}}{{S}_{0}} ) \times {( \frac{1}{{q}_{2 n}} )}^{b 2} & ( 39 )\end{matrix}$$

Where a2 and b2 are coefficients determined according to characteristics of the second stage ultraviolet ray irradiating unit.

The processing in step S79 to step S86 is performed on each second stage ultraviolet ray irradiating unit. Further, in step S84 and step S86, an output of each ultraviolet lamp 32 of the second stage ultraviolet ray irradiating unit 19 is adjusted.

Next, the controller 27 calculates target microorganism virtual concentrations N₂₁, N₂₂, . . . and N₂ₙ at outlets of the second stage ultraviolet ray irradiating units 19 based on equation (40) (step S88).

$$\begin{matrix}[ Mathematical 40 ] & \\ {N}_{2 n} = \frac{{N}_{IN}}{{10}^{\frac{{RED}_{2 n}}{{D}_{0 }}}} & ( 40 )\end{matrix}$$

Where

D₀: Inactivation velocity constant of target microorganisms (mJ/cm²), and

is an ultraviolet ray irradiation amount required to perform 1 Log inactivation on the target microorganisms.

Subsequently, the controller 27 calculates a target pathogenic microorganism virtual concentration N₃ in a water pipe 21 based on equation (41) (step S89).

$$\begin{matrix}[ Mathematial 41 ] & \\ {N}_{3} = \frac{{{\sum }^{n}}_{1} ( {N}_{2 n} \times {q}_{2 n} )}{Q} & ( 41 )\end{matrix}$$

Where Q is a total flow rate and is calculated based on equation (42).

$$\begin{matrix}[ Mathematical 42 ] & \\ Q = {\sum }_{1}^{n} {q}_{2 n} & ( 42 )\end{matrix}$$

Subsequently, the controller 27 calculates a required ultraviolet ray irradiation amount RED₃ₜ in the third stage ultraviolet ray irradiating unit 23 based on equation (43) (step S90).

$$\begin{matrix}[ Mathematical 43 ] & \\ {RED}_{3 t} = {D}_{0} \times Log ( \frac{{N}_{3}}{{N}_{OUT}} ) & ( 43 )\end{matrix}$$

Further, the controller 27 reads a third stage flow rate q3 based on the output of the flowmeter 23 (step S91).

q₃=Q holds.

In parallel to this, the controller 27 reads an output (ultraviolet ray intensity) S₃ of the ultraviolet ray intensity sensors UVS attached to the third stage ultraviolet ray irradiating units 23 (step S92).

As a result, the controller 27 calculates a goal ultraviolet ray intensity S₃ₜ of the ultraviolet ray intensity sensor UVS attached to the third stage ultraviolet ray irradiating unit 23 based on equation (44) (step S93).

$$\begin{matrix}[ Mathematical 44 ] & \\ {S}_{3 t} = {S}_{0} \times \frac{{RED}_{3 t}}{a 3} \times {Q}^{b 3} & ( 44 )\end{matrix}$$

Where a3 and b3 are coefficients determined according to characteristics of the third stage ultraviolet ray irradiating unit 23.

Next, the controller 27 compares the output S₃ of the ultraviolet ray intensity sensor UVS attached to the third stage ultraviolet ray irradiating unit 23 with the goal ultraviolet ray intensity S₃ₜ, and determines whether or not the output S₃ of the ultraviolet ray intensity sensor UVS coincides with the goal ultraviolet ray intensity S₃ₜ (S₃=S₃ₜ) (step S94).

When it is determined in step S94 that the output S₃ of the ultraviolet ray intensity sensor UVS coincides with the goal ultraviolet ray intensity S₃ₜ (step S94; Yes), the controller 27 moves processing to step S67.

When it is determined in step S94 that the output S₃ of the ultraviolet ray intensity sensor UVS does not coinicide with the goal ultraviolet ray intensity S₃ₜ (step S94; No), the controller 27 compares the output S₃ of the ultraviolet ray intensity sensor UVS attached to the third stage ultraviolet ray irradiating unit 23 with the goal ultraviolet ray intensity S₃ₜ, and determines whether or not the output S₃ of the ultraviolet ray intensity sensor UVS is smaller than the goal ultraviolet ray intensity S₃ₜ (S₃<S₃ₜ) (step S95).

When it is determined in step S95 that the output S₃ of the ultraviolet ray intensity sensor UVS is larger than the goal ultraviolet ray intensity S₃ₜ (S₃>S₃ₜ) (step S95; No), the controller 27 lowers the ultraviolet lamp output of the third stage ultraviolet ray irradiating unit 23 by a predetermined amount (step S96), and moves processing to step S97.

Meanwhile, when it is determined in step S95 that the output S₃ of the ultraviolet ray intensity sensor UVS is smaller than the goal ultraviolet ray intensity S₃ₜ (S₃<S₃t) (step S95; Yes), the controller 27 moves processing to step S97.

In step S97, the controller 27 determines whether or not the ultraviolet lamp output of the third stage ultraviolet ray irradiating unit 23 is 100% ( ).

When it is determined in step S94 that the ultraviolet lamp output of the third stage ultraviolet ray irradiating unit 23 is less than 100% (step S97; No), the controller 27 increases the ultraviolet lamp output of the third stage ultraviolet ray irradiating unit 23 by a predetermined amount (step S98), and moves processing to step S67.

When it is determined in step S93 that the ultraviolet lamp output of the third stage ultraviolet ray irradiating unit 23 is 100%, the ultraviolet lamp output cannot be increased more and processing becomes insufficient, and therefore a warning that an irradiation amount is insufficient is issued (step S99).

In step S96 and step S98, an output of each ultraviolet lamp 32 of the third stage ultraviolet ray irradiating unit 23 is adjusted.

Next, an effect according to the third embodiment will be described.

Individual ultraviolet ray irradiating units can be easily disposed at narrow places, and can be easily introduced in an existing facility. Consequently, according to the present embodiment, it is possible to select sizes of ultraviolet ray irradiating units according to a pipe diameter per place at which the ultraviolet ray irradiating units are disposed. Consequently, processing target water is irradiated with all ultraviolet rays emitted from ultraviolet lamps. Consequently, the liquid processing system according to the present embodiment can operate the liquid processing system with high irradiation efficiency and effectively reduce operation cost. Further, according to the present embodiment, an expanding pipe and a reducing pipe for adjusting pipe diameters are not required.

At a water purifying plant at which water is taken from a plurality of wells, water is intermittently taken frequently according to changes in water amounts, water levels and water quality of the individual wells. According to the third embodiment, it is possible to operate the first stage ultraviolet ray irradiating units according to changes in pumping statuses, flow rates or water quality of individual pumps. Further, the second stage and third stage ultraviolet ray irradiating units can also control irradiation amounts according to flow rates or water quality of individual units. Consequently, the liquid processing system according to the present embodiment can realize ultraviolet processing with little waste in an entire facility.

Further, according to the configuration of the water processing system according to the third embodiment, a sum of ultraviolet ray irradiation amounts of the first stage, the second stage and the third stage only needs to be a required ultraviolet ray irradiation amount or more. Ultraviolet ray irradiating units arranged in series can mutually make up for irradiation performance. Consequently, even when part of ultraviolet ray irradiating units are stopped due to, for example, regular maintenance or failure, it is possible to realize stable ultraviolet processing by making up for the irradiating performance in the entire system.

### Fourth Embodiment

Next, the fourth embodiment will be described.

A configuration of an ultraviolet water processing system according to the fourth embodiment is basically the same as that in the first embodiment. However, in the fourth embodiment, a final stage water processing line is operated as a preliminary processing line. Upon a normal time, the final stage water processing line stops operating or operates in a standby mode which suppresses ultraviolet lamp outputs at a control lower limit. Upon an unsteady time when water quality or a water level rapidly changes, a previous stage ultraviolet ray irradiating unit goes out of order, maintenance is executed or the like, the final stage water processing line operates, for example.

Next, a water processing system according to the fourth embodiment will be described.

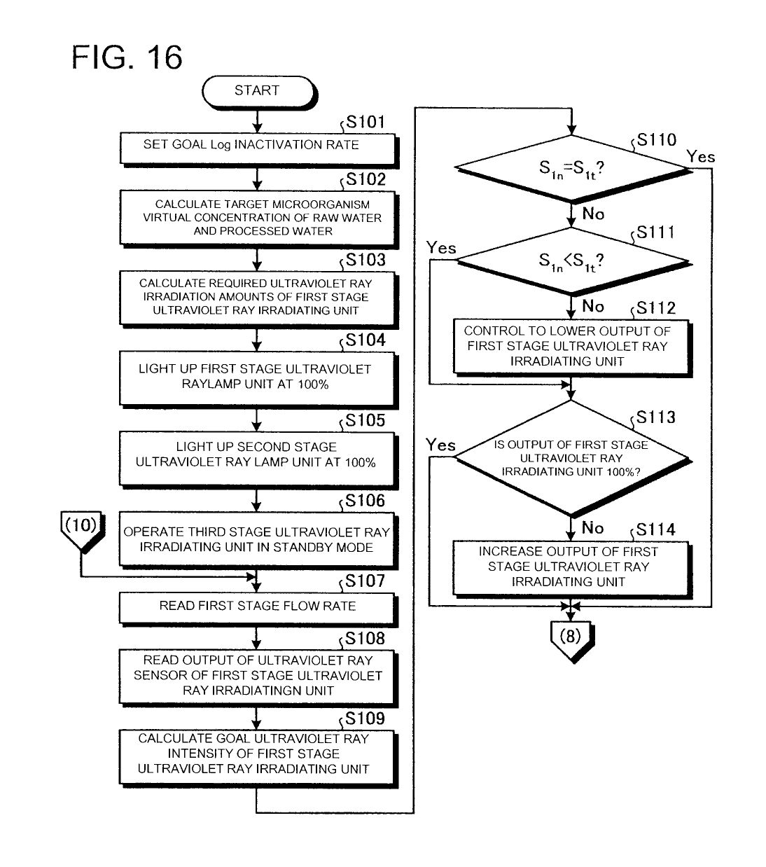

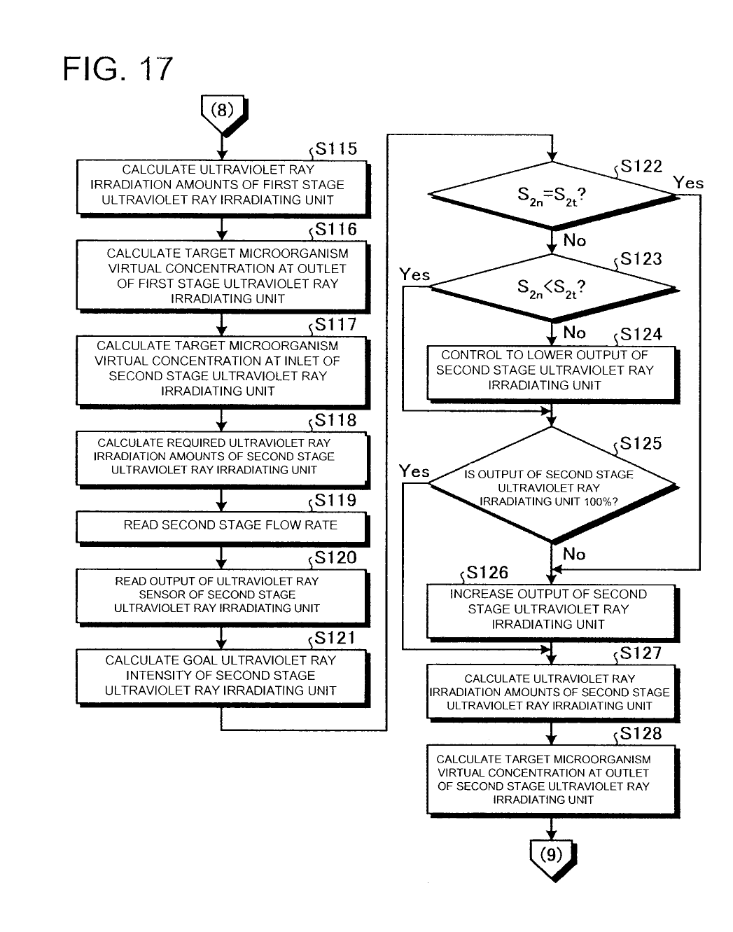

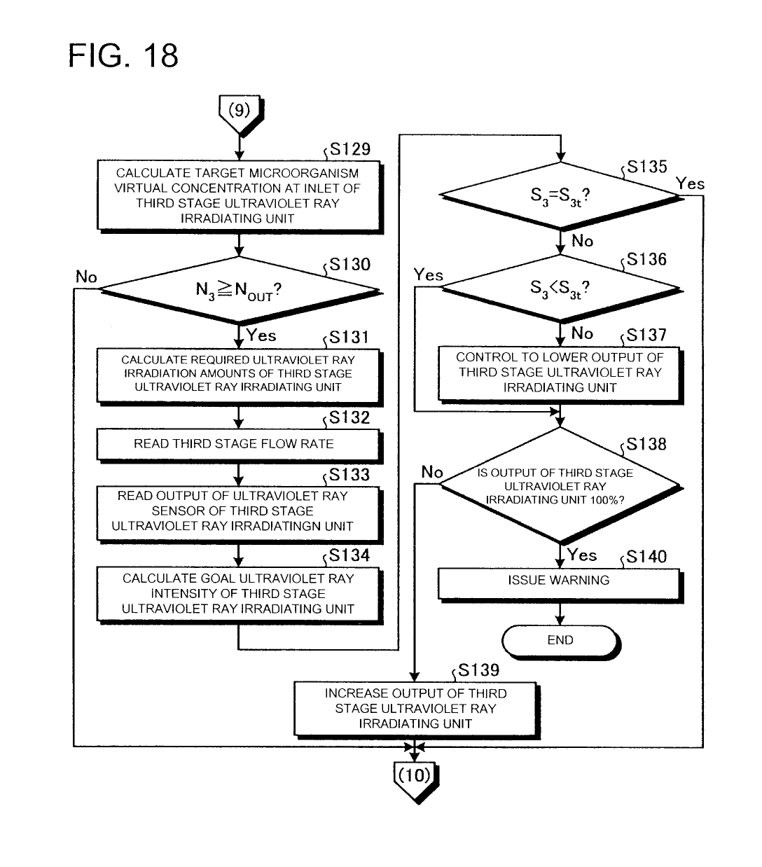

FIG. 16 is a processing flowchart (part 1) of the water processing system according to the fourth embodiment. FIG. 17 is a processing flowchart (part 2) of the water processing system according to the fourth embodiment. FIG. 18 is a processing flowchart (part 3) of the water processing system according to the fourth embodiment.

First, a controller 27 sets a goal Log inactivation rate ILog of a disinfection target pathogenic microorganisms (step S101). For example, ILog=3 Log holds.

Next, the controller 27 calculates a target microorganism virtual concentration N_{IN} of raw water and a target microorganism virtual concentration N_{OUT} of processed water based on equation (45) and equation (46) (step S102).

$$\begin{matrix} [ Mathematical 45 ] & \\ Raw water virtual concentration {N}_{1 N} = {10}^{I} ( pfu \text{/} mL ) & ( 45 ) \\ [ Mathematical 46 ] & \\ Processed water virtual concentration {N}_{OUT} = \frac{{10}_{IN}}{{10}^{I}} ( pfu \text{/} mL ) & ( 46 )\end{matrix}$$

Where the virtual concentration is used in order to calculate an ultraviolet ray irradiation amount of each of ultraviolet ray irradiating units 14, 19 and 23 in the subsequent steps for convenience sake, and is different from an actual microorganism concentration.

Next, the controller 27 calculates a required ultraviolet ray irradiation amount (RED) of the first stage ultraviolet ray irradiating unit 14 based on equation (47) (step S103).

$$\begin{matrix}[ Mathematical 47 ] & \\ {RED}_{1 t} = {D}_{0} \times Log ( \frac{{N}_{IN}}{{N}_{OUT}} ) & ( 47 )\end{matrix}$$

Subsequently, the controller 27 lights up each first stage ultraviolet ray irradiating unit 14 at 100% of the ultraviolet lamp output (step S104). That is, each ultraviolet lamp 32 emits light at 100% of the output.

Further, the controller 27 lights up each second stage ultraviolet ray irradiating unit 19 at 100% of the ultraviolet lamp output (step S105). That is, each ultraviolet lamp 32 emits light at 100% of the output.

Further, the controller 27 operates the third stage ultraviolet ray irradiating unit 23 in a standby mode (step S106).

In the standby mode, the third stage ultraviolet ray irradiating unit 23 is lighted up at a controllable lower limit of the ultraviolet lamp output. The controllable lower limit is minimum power at which a lighted state of an ultraviolet lamp can be stably maintained.

Subsequently, the controller 27 reads first stage flow rates q₁₁, q₁₂, . . . and q₁ₙ based on outputs of flowmeters 13 (step S107).

In parallel to this, the controller 27 reads outputs (ultraviolet ray intensities) S₁₁, S₁₂, . . . and S₁ₙ of the ultraviolet ray intensity sensors UVS attached to the first stage ultraviolet ray irradiating units 14 (step S108).

Next, the controller 27 calculates a goal ultraviolet ray intensity S₁ₜ of the ultraviolet ray intensity sensor UVS attached to the first stage ultraviolet ray irradiating unit 14 based on equation (48) (step S109).

$$\begin{matrix}[ Mathematical 48 ] & \\ {S}_{1 t} = {S}_{0} \times \frac{{RED}_{1 t}}{a 1} \times {Q}^{b 1} & ( 48 )\end{matrix}$$

Where a1 and b1 are coefficients determined according to characteristics of the first stage ultraviolet ray irradiating unit 14.

Subsequently, the controller 27 compares the output S₁ₙ of the ultraviolet ray intensity sensor UVS attached to the first stage ultraviolet ray irradiating unit 14 with the goal ultraviolet ray intensity S₁ₜ, and determines whether or not the output S₁ₙ of the ultraviolet ray intensity sensor UVS coincides with the goal ultraviolet ray intensity S₁ₜ (S₁ₙ=S₁ₜ) (step S110).

When it is determined in step S110 that the output S₁ₙ of the ultraviolet ray intensity sensor UVS coincides with the goal ultraviolet ray intensity S₁ₜ (step S110; Yes), the controller 27 moves processing to step S115.

When it is determined in step S110 that the output S₁ₙ of the ultraviolet ray intensity sensor UVS does not coincide with the goal ultraviolet ray intensity S₁ₜ (step S110; No), the controller 27 compares the output S₁ₙ of the ultraviolet ray intensity sensor UVS attached to the first stage ultraviolet ray irradiating unit 14 with the goal ultraviolet ray intensity S₁ₜ, and determines whether or not the output S₁ₙ of the ultraviolet ray intensity sensor UVS is smaller than the goal ultraviolet ray intensity S₁ₜ (S₁ₙ<S₁ₜ) (step S111).

When it is determined in step S111 that the output S₁ₙ of the ultraviolet ray intensity sensor UVS is larger than the goal ultraviolet ray intensity S₁ₜ (S₁ₙ>S₁ₜ) (step S111; No), the controller 27 lowers the ultraviolet lamp output of the first stage ultraviolet ray irradiating unit 14 by a predetermined amount (step S112), and moves processing to step S113.

When it is determined in step S111 that the output S₁ₙ of the ultraviolet ray intensity sensor UVS is smaller than the goal ultraviolet ray intensity S₁ₜ (S₁ₙ<S₁ₜ) (step S111; Yes), the controller 27 moves processing to step S113.

In step S113, the controller 27 determines whether or not the ultraviolet lamp output of the first stage ultraviolet ray irradiating unit 14 is 100%.

When it is determined in step S113 that the ultraviolet lamp output of the first stage ultraviolet ray irradiating unit 14 is 100% (step S113; Yes), the controller 27 moves processing to step S115.

When it is determined in step S113 that the ultraviolet lamp output of the first stage ultraviolet ray irradiating unit 14 is less than 100% (step S113; No), the controller 27 increases the ultraviolet lamp output of the first stage ultraviolet ray irradiating unit 14 by a predetermined amount (step S114), and moves processing to step S115.

The processing in step S107 to step S114 is performed on each first stage ultraviolet ray irradiating unit 14. Further, in step S112 and step S114, an output of each ultraviolet lamp 32 of the first stage ultraviolet ray irradiating unit 14 is adjusted.

Subsequently, the controller 27 calculates conversion equivalent ultraviolet ray irradiation amount RED₁₁, RED₁₂, RED₁₃, . . . and RED₁ₙ of the respective first stage ultraviolet ray irradiating units 14 based on equation (49) (step S115).

$$\begin{matrix}[ Mathematical 49 ] & \\ {RED}_{1 n} = a 1 \times ( \frac{{S}_{1 n}}{{S}_{0}} ) \times {( \frac{1}{{q}_{1 n}} )}^{b 1} & ( 49 )\end{matrix}$$

Where a1 and b1 are coefficients determined according to characteristics of the first stage ultraviolet ray irradiating unit.

Next, the controller 27 calculates target microorganism virtual concentrations N₁₁, N₁₂, N₁₃, . . . and N₁ₙ at outlets of the first stage ultraviolet ray irradiating units 14 based on equation (50) (step S116).

$$\begin{matrix}[ Mathematical 50 ] & \\ {N}_{1 n} = {N}_{IN} / {10}^{\frac{{RED}_{1 n}}{{D}_{0}}} & ( 50 )\end{matrix}$$

Where

D₀: Inactivation velocity constant of target microorganisms (mJ/cm²), and

is an ultraviolet ray irradiation amount required to perform 1 Log inactivation on the target microorganisms.

Next, the controller 27 calculates a target pathogenic microorganism virtual concentration N₂ in a distributing pipe 16 based on equation (51) (step S117).

$$\begin{matrix}[ Mathematical 51 ] & \\ {N}_{2} = \frac{{\sum }_{1}^{n} ( {N}_{1 n} \times {q}_{1 n} )}{Q} & ( 51 )\end{matrix}$$

Where Q is a total flow rate and is calculated based on equation (52).

$$\begin{matrix}[ Mathematical 52 ] & \\ Q = {\sum }_{1}^{n} {q}_{1 n} & ( 52 )\end{matrix}$$

Subsequently, the controller 27 calculates a required ultraviolet ray irradiation amount RED₂ₜ of the second stage ultraviolet ray irradiating unit 19 based on equation (53) (step S118).

$$\begin{matrix}[ Mathematical 53 ] & \\ {RED}_{2 t} = {D}_{0} \times Log ( \frac{{N}_{2}}{{N}_{OUT}} ) & ( 53 )\end{matrix}$$

Further, the controller 27 reads second stage flow rates q₂₁, q₂₂, . . . and q₂ₙ based on outputs of flowmeters 18 (step S119).

Furthermore, the controller 27 reads outputs (ultraviolet ray intensities) S₂₁, S₂₂, . . . and S₂ₙ of the ultraviolet ray intensity sensors UVS attached to the respective second stage ultraviolet ray irradiating units 19 (step S120).

As a result, the controller 27 calculates a goal ultraviolet ray intensity of the ultraviolet ray intensity sensor UVS attached to the second stage ultraviolet ray irradiating unit 19 based on equation (54) (step S121).

$$\begin{matrix}[ Mathematical 54 ] & \\ {S}_{2 t} = {S}_{0} \times \frac{{RED}_{2 t}}{a 2} \times {Q}^{b 2} & ( 54 )\end{matrix}$$

Where a2 and b2 are coefficients determined according to characteristics of the second stage ultraviolet ray irradiating unit.

Next, the controller 27 compares the output S₂ₙ of the ultraviolet ray intensity sensor UVS attached to the second stage ultraviolet ray irradiating unit 19 with the goal ultraviolet ray intensity S₂ₜ, and determines whether or not the output S₂ₙ of the ultraviolet ray intensity sensor UVS coincides with the goal ultraviolet ray intensity S₂ₜ (S₂ₙ=S₂ₜ) (step S122).

When it is determined in step S122 that the output S₂ₙ of the ultraviolet ray intensity sensor UVS attached to the second stage ultraviolet ray irradiating unit 19 coincides with the goal ultraviolet ray intensity S₂ₜ (step S122; Yes), the controller 27 moves processing to step S126.

When it is determined in step S122 that the output S₂ₙ of the ultraviolet ray intensity sensor UVS attached to the second stage ultraviolet ray irradiating unit 19 does not coincide with the goal ultraviolet ray intensity S₂ₜ (step S122; No), the controller 27 compares the output S₂ₙ of the ultraviolet ray intensity sensor UVS attached to the second stage ultraviolet ray irradiating unit 19 with the goal ultraviolet ray intensity S₂ₜ, and determines whether or not the output S₂ₙ of the ultraviolet ray intensity sensor UVS is smaller than the goal ultraviolet ray intensity S₂ₜ (S₂ₙ<S₂ₜ) (step S123).

When it is determined in step S123 that the output S₂ₙ of the ultraviolet ray intensity sensor UVS is larger than the goal ultraviolet ray intensity S₂ₜ (S₂ₙ>S₂ₜ) (step S123; No), the controller 27 lowers the ultraviolet lamp output of the second stage ultraviolet ray irradiating unit 19 by a predetermined amount (step S124), and moves processing to step S125.

Meanwhile, when it is determined in step S123 that the output S₂ₙ of the ultraviolet ray intensity sensor UVS is smaller than the goal ultraviolet ray intensity S₂ₜ (S₂ₙ<S₂ₜ) (step S123; Yes), the controller 27 moves processing to step S125.

In step S125, the controller 27 determines whether or not the ultraviolet lamp output of the second stage ultraviolet ray irradiating unit 19 is 100%.

When it is determined in step S125 that the ultraviolet lamp output of the second stage ultraviolet ray irradiating unit 19 is less than 100% (step S125; No), the controller 27 increases the ultraviolet lamp output of the second stage ultraviolet ray irradiating unit 19 by a predetermined amount (step S126), and moves processing to step S127.

The processing in step S119 to step S127 is performed on each second stage ultraviolet ray irradiating unit 19. Further, in step S124 and step S126, an output of each ultraviolet lamp 32 of the second stage ultraviolet ray irradiating unit 19 is adjusted.

When it is determined in step S125 that the ultraviolet lamp output of the second stage ultraviolet ray irradiating unit 19 is 100% (step S125; Yes), the controller 27 moves processing to step S127.

In step S127, the controller 27 calculates conversion equivalent ultraviolet ray irradiation amounts RED₂₁, RED₂₂, . . . and RED₂ₙ of the respective second stage ultraviolet ray irradiating units 19 based on equation (55).

$$\begin{matrix}[ Mathematical 55 ] & \\ {RED}_{2 n} = a 2 \times ( \frac{{S}_{2 n}}{{S}_{0}} ) \times {( \frac{1}{{q}_{2 n}} )}^{b 2} & ( 55 )\end{matrix}$$

Where a2 and b2 are coefficients determined according to characteristics of the second stage ultraviolet ray irradiating unit.

Subsequently, the controller 27 calculates target microorganism virtual concentrations N₂₁, N₂₂, . . . and N₂ₙ at outlets of the respective second stage ultraviolet ray irradiating units 19 based on equation (56) (step S128).

$$\begin{matrix}[ Mathematical 56 ] & \\ {N}_{2 n} = {N}_{IN} / {10}^{\frac{{RED}_{2 n}}{{D}_{0}}} & ( 56 )\end{matrix}$$

Where

D₀: Inactivation velocity constant of target microorganisms (mJ/cm²), and is an ultraviolet ray irradiation amount required to perform 1 Log inactivation on the target microorganisms.

Subsequently, the controller 27 calculates a target pathogenic microorganism virtual concentration N₃ in a water pipe 21 based on equation (57) (step S129).

$$\begin{matrix}[ Mathematical 57 ] & \\ {N}_{3} = \frac{{\sum }_{1}^{n} ( {N}_{2 n} \times {q}_{2 n} )}{Q} & ( 57 )\end{matrix}$$

Where Q is a total flow rate and is calculated based on equation (58).

$$\begin{matrix}[ Mathematical 58 ] & \\ Q = {\sum }_{1}^{n} {q}_{2 n} & ( 58 )\end{matrix}$$

Subsequently, the controller 27 compares the target pathogenic microorganism virtual concentration N₃ in the water pipe 21 with a processed water virtual concentration N_{OUT}, and determines whether or not the target pathogenic microorganism virtual concentration N₃ is N_{OUT} or more (N₃≧N_{OUT}) (step S130).

It is determined in step S130 that the controller 27 is not normal. When the target pathogenic microorganism virtual concentration N₃ is the processed water virtual concentration N_{OUT} or more (N₃≧N_{OUT}), the controller 27 is steady. Further, when the target pathogenic microorganism virtual concentration N₃ is smaller than the processed water virtual concentration N_{OUT}(N₃<N_{OUT}), the controller 27 is unsteady.

When it is determined in step S130 that the target pathogenic microorganism virtual concentration N₃ is smaller than the processed water virtual concentration N_{OUT} (N₃<N_{OUT}) (step S130; No), the controller 27 continues an operation of a standby mode, and moves processing to step S107.

Further, when it is determined in step S130 that the target pathogenic microorganism virtual concentration N₃ is the processed water virtual concentration N_{OUT} or more (N₃≧N_{OUT}) (step S130; No), the controller 27 calculates a required ultraviolet ray irradiation amount RED₃ₜ of the third stage ultraviolet ray irradiating unit 23 based on equation (59) (step S131).

$$\begin{matrix}[ Mathematical 59 ] & \\ {RED}_{3 t} = {D}_{0} \times Log ( \frac{{N}_{3}}{{N}_{OUT}} ) & ( 59 )\end{matrix}$$

In parallel to this, the controller 27 reads a third stage flow rates q₃ based on the output of a flowmeter 22 (step S132).

q₃=Q holds.

Further, the controller 27 reads an output (ultraviolet ray intensity) S₃ of the ultraviolet ray intensity sensors UVS attached to the third stage ultraviolet ray irradiating units 23 (step S133).

Furthermore, the controller 27 calculates a goal ultraviolet ray intensity S₃ₜ of the ultraviolet ray intensity sensor UVS attached to the third stage ultraviolet ray irradiating unit 23 based on equation (60) (step S134).

$$\begin{matrix}[ Mathematical 60 ] & \\ {S}_{3 t} = {S}_{0} \times \frac{{RED}_{3 t}}{a 3} \times {Q}^{b 3} & ( 60 )\end{matrix}$$

Where a3 and b3 are coefficients determined according to characteristics of the third stage ultraviolet ray irradiating unit.

Subsequently, the controller 27 compares the output S₃ of the ultraviolet ray intensity sensor UVS attached to the third stage ultraviolet ray irradiating unit 23 with the goal ultraviolet ray intensity S₃ₜ, and determines whether or not the output S₃ of the ultraviolet ray intensity sensor UVS coincides with the goal ultraviolet ray intensity S₃ₜ (S₃=S₃ₜ) (step S135).

When it is determined in step S135 that the output S₃ of the ultraviolet ray intensity sensor UVS attached to the third stage ultraviolet ray irradiating unit 23 coincides with the goal ultraviolet ray intensity S₃ₜ (step S135; Yes), the controller 27 moves processing to step S107.

When it is determined in step S135 that the output S₃ of the ultraviolet ray intensity sensor UVS attached to the third stage ultraviolet ray irradiating unit 23 does not coincide with the goal ultraviolet ray intensity S₃ₜ (step S135; No), the controller 27 compares the output S₃ of the ultraviolet ray intensity sensor UVS attached to the third stage ultraviolet ray irradiating unit 23 with the goal ultraviolet ray intensity S₃ₜ, and determines whether or not the output S₃ of the ultraviolet ray intensity sensor UVS is smaller than the goal ultraviolet ray intensity S₃ₜ (S₃<S₃ₜ) (step S136).

When it is determined in step S136 that the output S₃ of the ultraviolet ray intensity sensor UVS is larger than the goal ultraviolet ray intensity S₃ₜ (S₃>S₃ₜ) (step S136; No), the controller 27 lowers the ultraviolet lamp output of the third stage ultraviolet ray irradiating unit 23 by a predetermined amount (step S137), and moves processing to step S138.

Meanwhile, when it is determined in step S136 that the output S₃ of the ultraviolet ray intensity sensor UVS is smaller than the goal ultraviolet ray intensity S₃ₜ (S₃<S₃ₜ) (step S136; Yes), the controller 27 moves processing to step S138.

In step S138, the controller 27 determines whether or not the ultraviolet lamp output of the third stage ultraviolet ray irradiating unit 23 is 100%.

When it is determined in step S138 that the ultraviolet lamp output of the third stage ultraviolet ray irradiating unit 23 is less than 100% (step S138; No), the controller 27 increases the ultraviolet lamp output of the third stage ultraviolet ray irradiating unit 23 by a predetermined amount (step S139), and moves processing to step S107.

When it is determined in step S138 that the ultraviolet lamp output of the third stage ultraviolet ray irradiating unit 23 is 100%, the controller 27 issues a warning that an irradiation amount is insufficient (step S140) and finishes processing.

Next, an effect according to the fourth embodiment will be described.

According to the fourth embodiment, the final stage of the ultraviolet disinfecting system configured to have a plurality of stages operates as a backup deveice. Upon a normal time, the final stage water processing line stops operating or operates in a standby mode which suppresses ultraviolet lamp outputs at a control lower limit. Upon an unsteady time when water quality or a water level rapidly changes, a previous stage ultraviolet ray irradiating unit goes out of order, maintenance is executed and the like, the final stage water processing line operates, for example. Consequently, even upon an unsteady time, it is possible to stably operate the water processing system (ultraviolet disinfecting system) at all times without stopping the water processing system.

Further, according to the fourth embodiment, a sum of ultraviolet ray irradiation amounts of the first stage, the second stage and the third stage only needs to be a required ultraviolet ray irradiation amount or more. Individual ultraviolet ray irradiating units can be easily disposed at narrow places, and can be easily introduced in an existing facility.

Further, according to the fourth embodiment, by selecting sizes of ultraviolet ray irradiating units according to a pipe diameter per place at which the ultraviolet ray irradiating units are disposed, processing target water is irradiated with all ultraviolet rays emitted from ultraviolet lamps. Consequently, the liquid processing system according to the present embodiment can operate the liquid processing system with high irradiation efficiency and effectively reduce operation cost. Further, according to the present embodiment, an expanding pipe and a reducing pipe for adjusting pipe diameters are not required.

At a water purifying plant at which water is taken from a plurality of wells, water is intermittently taken frequently according to changes in water amounts, water levels and water quality of the individual wells. According to the fourth embodiment, it is possible to operate the first stage ultraviolet ray irradiating units according to changes in pumping statuses, flow rates or water quality of individual pumps. Further, the second stage and third stage ultraviolet ray irradiating units can also control irradiation amounts according to flow rates or water quality of individual units. Consequently, the liquid processing system according to the present embodiment can realize ultraviolet processing with little waste in an entire facility.

The same case of the ultraviolet disinfecting system as that of the first embodiment has been described as examples in the third embodiment and the fourth embodiment. However, the ultraviolet water processing system whose object is to dissolve or remove materials which cause coloring or odor of processing target water can be realized similar to the second embodiment.

### [5] Modification of Embodiments

A control program executed by a control device (e.g. controller) of a liquid processing system according to the present embodiment is provided by being recorded as an installable format or executable format file in a computer-readable medium such as a CD-ROM, a flexible disk (FD), a CD-R and a DVD (Digital Versatile Disk).

Further, a control program executed by the control device (e.g. controller) of the liquid processing system according to the present embodiment may be configured to be provided by being stored on a computer connected to a network such as the Internet and downloaded through the network. Furthermore, the control program executed by the control device of the liquid processing system according to the present embodiment may be configured to be provided or distributed through the network such as the Internet.

Still further, the control program of the control device of the liquid processing system according to the present embodiment may be configured to be provided by being implemented in, for example, ROM in advance.

Some embodiments of the present invention have been described above. However, these embodiments have been presented as exemplary embodiments and are not intended to limit the scope of the invention. These new embodiments can be carried out in various other modes, and various omission, substitution and changes can be made without departing from the spirit of the inventions. The embodiments and the modifications are incorporated in the scope and the spirit of the invention, and are incorporated in a range of the invention recited in the claims and their equivalent.

### REFERENCE SIGNS LIST

10, 100 WATER PROCESSING SYSTEM (LIQUID PROCESSING SYSTEM)
11 WELL
12 INTAKE PIPE
13 FLOWMETER
14 FIRST STAGE ULTRAVIOLET RAY IRRADIATING UNIT
15 COLLECTING PIPE
16 DISTRUSTING PIPE
17 WATER PIPE
18 FLOWMETER
19 SECOND STAGE ULTRAVIOLET RAY IRRADIATING UNIT
20 COLLECTING PIPE
21 WATER PIPE
22 FLOWMETER
23 THIRD STAGE ULTRAVIOLET RAY IRRADIATING UNIT
24 CLEAR WATER RESERVOIR
25 DISINFECTANT INJECTING DEVICE
26 WATER PIPE
27 CONTROLLER (ADJUSTING SECTION)
31 WATER DRUM
32, 32a, 32b, 32c ULTRAVIOLET RAY IRRADIATING TUBE
33, 33a, 33b FLANGE JOINT
34a, 34b, 34c BUSHING
35 ULTRAVIOLET LAMP
36 SILICA GLASS TUBE
39 CAP
40 POSITIONING SEGMENT
41 WIRE
101 PROCESSING TARGET WATER TANK
UVS ULTRAVIOLET RAY INTENSITY SENSOR

What is claimed is:

1. A liquid processing system comprising;
processing units of n stages in total (n is a natural number of two or more), each processing unit including one or a plurality of processing lines, each processing line including an ultraviolet ray irradiating unit, and the number of processing lines of an m-th (m is a natural number smaller than n) stage processing unit being larger than the number of processing lines of an m+1-th stage processing unit; and
adjusting section which adjusts an output of an ultraviolet ray irradiating unit provided to a processing unit of a predetermined stage, wherein
an output of an ultraviolet ray irradiating unit provided to a processing unit of a stage other than the predetermined stage is each fixed, and
the adjusting section adjusts the output of the ultraviolet ray irradiating unit provided to the processing unit of the predetermined stage such that a liquid processed in an n-th stage processing unit of a final stage is in a desired processing state.

2. The liquid processing system according to claim 1, wherein the adjusting section fixes to a maximum output the output of the ultraviolet ray irradiating unit provided to the stage other than the predetermined stage.

3. The liquid processing system according to claim 1, wherein the number of processing lines at the final stage is one line.

4. The liquid processing system according to claim 1, wherein
each processing line of the processing unit of the predetermined stage includes a flowmeter on an upstream side of the ultraviolet ray irradiating unit, and
the adjusting section adjusts the output of the ultraviolet ray irradiating unit provided to the processing unit of the predetermined stage based on a flow rate obtained by the flowmeter.

5. The liquid processing system according to claim 1, wherein the liquid is an aqueous liquid.

6. The liquid processing system according to claim 1, further comprising:
a collecting pipe which collects a liquid of each processing line of the m-th stage processing unit, and
a distributing pipe which is connected to the collecting pipe, and distributes the liquid from the collecting pipe to each processing line to the m+1-th stage processing unit.

7. A control method which is executed in a liquid processing system which comprises: processing units of n stages in total (n is a natural number of two or more), each processing unit including one or a plurality of processing lines, each processing line including an ultraviolet ray irradiating unit, and the number of processing lines of an m-th (m is a natural number smaller than n) stage processing unit being larger than the number of processing lines of an m+1-th stage processing unit; and
adjusting section which adjusts an output of an ultraviolet ray irradiating unit provided to a processing unit of a predetermined stage, the control method comprising:
fixing an output of an ultraviolet ray irradiating unit provided to a processing unit of a stage other than the predetermined stage, and
adjusting the output of the ultraviolet ray irradiating unit provided to the processing unit of the predetermined stage such that a liquid processed in processing lines of an n-th stage processing unit of a final stage is in a desired processing state.
